(19) United States
(12) Patent Application Publication
(10) Pub. No.: US 2008/0238843 A1
(43) Pub. Date: Oct. 2, 2008

(54) LIQUID CRYSTAL DEVICE, DRIVING CIRCUIT FOR LIQUID CRYSTAL DEVICE, METHOD OF DRIVING LIQUID CRYSTAL DEVICE, AND ELECTRONIC APPARATUS

(75) Inventor: Satoshi YATABE, Shiojiri-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/040,307

(22) Filed: Feb. 29, 2008

(30) Foreign Application Priority Data
Mar. 29, 2007 (JP) 2007-088282

(51) Int. Cl. G09G 3/36

(52) U.S. Cl. 345/87

(57) ABSTRACT

A liquid crystal device includes a substrate having pixel electrodes disposed in correspondence with intersections of scanning lines and data lines, a common electrode disposed to face the pixel electrodes, a liquid crystal interposed between the substrate and another substrate, a scanning line driving circuit that sequentially supplies selection voltages for selecting the scanning lines to the scanning lines, a regular voltage source that supplies voltage to the common electrode corresponding to a pixel in a selection period, an auxiliary voltage source that supplies voltage to the common electrode corresponding to a pixel in a non-selection period, a control circuit that selects the voltage and supplies the selected voltage to the common electrode, and a data line driving circuit that alternately supplies a positive-polarity image signal and a negative-polarity image signal to the data lines when the scanning line is selected.

### BACKGROUND

1. Technical Field

The present invention relates to a liquid crystal device, a driving circuit for a liquid crystal device, a method of driving a liquid crystal device, and an electronic apparatus.

2. Related Art

In liquid crystal devices, in order to prevent so called image sticking, the polarity of voltage applied to a liquid crystal layer is required to be periodically inverted. A commonly used method of inverting the polarity is a method in which the voltage VCOM of a common electrode disposed on an opposing substrate is fixed and the voltage applied to a pixel electrode disposed on a substrate on the other side is alternately changed to have a positive polarity or a negative polarity with respect to the voltage VCOM of the common electrode.

However, in this method, it is needed to oscillate the voltage of the pixel electrode to the positive and negative sides from the voltage of the common electrode VCOM as a center, and the dynamic range of the voltage applied to the pixel electrode is increased, and thereby it becomes difficult to reduce the power consumption.

Here, when the voltage VCOM of the common electrode is alternately changed to the positive side or the negative side without being fixed and the voltage of the pixel electrode is alternately changed to be a polarity opposite to that of the voltage VCOM of the common electrode, the dynamic range of the voltage applied to the pixel electrode becomes half the dynamic range of a case where the voltage VCOM of the common electrode is fixed, and thereby the power consumption can be reduced.

However, in a liquid crystal device having a configuration that a liquid crystal layer is interposed between the pixel electrode and the common electrode disposed in the opposing substrate, the area of the common electrode disposed in the opposing substrate becomes large, and thereby it is difficult to invert the polarity of the common electrode VCOM at high speed.

Thus, in JP-A-2002-196358, a method in which one end of a storage capacitor (maintaining capacitor) disposed in each pixel is separated from the common electrode of the liquid crystal, the polarity of the voltage of one end of the storage capacitor is inverted, and charges are moved from the storage capacitor to the liquid crystal layer due to the polarity inversion has been proposed.

However, according to this method, one end of the storage capacitor and the common electrode of the liquid crystal are separated from each other, and it is apparent that the configuration of the pixel becomes complicated. Accordingly, it is preferable that the pixel configuration in which one end of the storage capacitor and the common electrode of the liquid crystal are integrally formed without being separated from each other is used and the polarity of the voltage VCOM of the common electrode is alternately inverted.

In addition, in the liquid crystal devices, while charge/discharge current (transient current due to crosstalk caused by parasitic capacitance, and hereinafter also referred to as crosstalk current) due to crosstalk caused by parasitic capacitance is generated, there is a case where reduction of the crosstalk current is needed so as to stabilize regular driving voltage and reduce the power consumption.

Technology for reducing the crosstalk current, for example, has been disclosed in JP-A-2004-271969. In JP-A-2004-271969, the crosstalk current is reduced by setting the voltage of the common electrode for pixels in a non-selection period in a floating state so as to block the current path.

As described above, in the liquid crystal devices, it is advantageous that an inversion method in which both the voltage VCOM of the common electrode and the voltage of the pixel electrode are alternately inverted to have opposite polarities is used for reducing the power consumption.

In addition, in order to prevent complicated configuration of the liquid crystal, it is preferable that a pixel configuration in which one end of the storage capacitor and the common electrode of the liquid crystal are integrally formed without being separated from each other is used and the polarity of the voltage VCOM of the common electrode is alternately inverted.

In addition, in order to implement a miniaturized and high performance liquid crystal device using the above-described driving method, it is important to reduce unnecessary power consumption due to the crosstalk current. In other words, an increase in the crosstalk current, for example, means that the load of an amplifier for driving the common line becomes heavier, which may be one reason for variations of the regular driving voltage. In addition, the increase in the crosstalk current disturbs reduction of the power consumption.

In the technology disclosed in JP-A-2004-271969, although the crosstalk current decreases, however, the voltage of the common electrode is in a floating state, and whereby the pixel voltage becomes unstable.

### SUMMARY

An advantage of some aspects of the invention is that it provides a liquid crystal device having a pixel configuration in which one end of the storage capacitor and the common electrode are connected together with a common line and being driven by alternately inverting the polarity of the driving voltage of the common line, a voltage with high precision can be supplied to the common line in a selection period by reducing the load of the regular amplifier used for driving the common line, and the power consumption due to the crosstalk current flowing through the parasitic capacitance can be reduced.

According to a first aspect of the invention, there is provided a liquid crystal device comprising: a first substrate having a plurality of scanning lines, a plurality of data lines, a plurality of pixel electrodes disposed in correspondence with intersections of the plurality of scanning lines and the plurality of data lines, and common electrode disposed to face the pixel electrodes a second substrate disposed to face the first substrate a liquid crystal interposed between the first substrate and the second substrate a scanning line driving circuit that sequentially supplies selection voltages for selecting the scanning lines to the plurality of scanning lines a regular voltage source that supplies a first voltage, which is a regular common electrode voltage having a negative polarity, and a second voltage, which is a regular common electrode voltage having a positive polarity, to be applied to the common electrode corresponding to a pixel in a selection period an auxiliary voltage source that supplies a third voltage, which is an auxiliary common electrode voltage having a negative polarity, and a fourth voltage, which is an auxiliary common electrode voltage having a positive, to be applied to the common electrode corresponding to a pixel in a non-selection period a control circuit that selects one from among the first voltage, the second voltage, the third voltage, and the fourth voltage and supplies the selected voltage to the common electrode; and a data line driving circuit that alternately supplies a positive-polarity image signal and a negative-polarity image signal to the plurality of data lines when the scanning line is selected. The control circuit supplies the first voltage to the common electrode, the scanning line driving circuit supplies the selection voltage to the scanning lines, the data line driving circuit supplies the positive polarity image signal to the data lines, and the control circuit supplies the third voltage to the common electrode after the supply of the selection voltage to the scanning lines is stopped, and the control circuit supplies the second voltage to the common electrode, the scanning line driving circuit supplies the selection voltage to the scanning lines, the data line driving circuit supplies the negative polarity image signal to the data lines, and the control circuit supplies the fourth voltage to the common electrode after the supply of the selection voltage to the scanning lines is stopped.

According to the aspect above, in a liquid crystal device of a common oscillation inversion driving type in which voltages of the common electrodes (common lines) are inverted, a method in which regular common electrode voltages (the first and second voltages) to be supplied to the common electrodes in the selection period of pixels and auxiliary common electrode voltages (the third and fourth voltages) to be supplied to the common electrodes in the non-selection period of pixels are appropriately applied is used. In this aspect, although common electrode voltages with high precision are required for writing data into pixels, the fact that the precision of the common electrode voltages for the non-selection period are not required to be as high as that for the writing period is considered. For example, after data is precisely written, even though there is a slight voltage variance, the voltage variance can be smoothly absorbed, for example, by a maintaining capacitor having sufficiently large capacitance such that the voltage applied to the liquid crystal can be maintained to a fixed value over the entire period of the maintaining period, and accordingly, the precision of the common electrode voltages in the non-selection period are not required to be as high as that for the writing period. Accordingly, in the aspect above, voltage sources for supplying voltages to the common electrodes are switched for the selection period and the non-selection period. Although crosstalk current is one factor for variances of voltages of the common electrodes, the first voltage and the second voltage with high precision are connected to the common electrodes only in the selection period. Thus, the regular voltage sources for supplying the first voltage and the second voltage are not influenced by crosstalk current from other pixels in the non-selection period, and accordingly, voltages with higher precision can be applied to the common electrodes for writing data into pixels. In addition, the circuit configuration of the auxiliary voltage sources for supplying the third voltage and the fourth voltage is not required to have a same high precision level as is required for data writing, the circuit configuration can be simplified. In addition, since there is no effect of the crosstalk current, the load of the regular voltage sources for generating the first voltage and the second voltage is lowered, and accordingly, the driving capability of the regular voltage source may be configured to be low. Therefore, even though an auxiliary voltage source having a simple configuration is added, the occupied area or the manufacturing cost is not increased in view of the whole circuit.

According to a second aspect of the invention, the common electrode is divided for each horizontal line.

In the aspect above, the polarity of voltage applied to each row can be determined by dividing the common electrode for each horizontal line, and thereby it is possible to employ a driving method that is advantageous for reduction of flicker.

According to a third aspect of the invention, the control circuit supplies the second voltage or the fourth voltage to the even row common electrodes when supplying the first voltage or the third voltage to the odd row common electrodes.

In the aspect above, flicker can be reduced by applying voltages having opposite polarities to common electrodes of adjacent rows.

According to a fourth aspect of the invention, each of the auxiliary voltage sources VSC1 and VSC2 for supplying the third voltage VCOML′ and the fourth voltage VCOMH′ includes capacitors CL and CH that are charged or discharged through a crosstalk current flowing through parasitic capacitance intervening between the data lines and the common electrode, and the level of the third voltage is equivalent to or approximately equal to that of the first voltage and the level of the fourth voltage is equivalent to or approximately equal to that of the second voltage.

In the aspect above, the capacitors are charged by crosstalk current caused by parasitic capacitance and the charged capacitors are used as primary voltage sources of the third voltage and the fourth voltage. According to the aspect above, the configuration is simple and the crosstalk current is used advantageously, and thereby it is possible to markedly reduce the power consumption. In addition, when a period having a considerable length is taken, the sum of charge/discharge currents (crosstalk current) through the parasitic capacitance between the date line and the common electrode due to variances of the voltage level of the data line becomes approximately zero, and accordingly, the capacitors effectively serve as the primary sources of charges for the common electrode in the non-selection period.

According to a fifth aspect of the invention, the auxiliary voltage source further includes a voltage limiting unit that limits the range of voltage variances of a voltage generated from the capacitor.

Since the variable widths of the generated voltages (the third voltage and the fourth voltage) cannot be regulated only by using the capacitors, the unit for limiting the variable widths of the voltages is additionally provided in the aspect above. Accordingly, it is possible to control the voltage variances of the third voltage and the fourth voltage within a predetermined width.

According to a sixth aspect of the invention, the voltage limiting unit is a Class-B amplifier having its output terminal connected to one end of the capacitor and having a dead zone of a predetermined width.

In the aspect above, a Class-B amplifier having a dead zone, serving as a voltage limiting unit, is connected to the capacitor. Accordingly, when the voltage applied to the capacitor varies within an allowed range, the output terminal of the B-Class amplifier is in a high impedance state due to the dead zone. On the other hand, when the voltage applied to the capacitor varies beyond the allowed range, the B-Class amplifier operates so as to regulate the voltage variance. Accordingly, it is possible to control the voltage variances of the third voltage and the fourth voltage within a predetermined width.

According to a seventh aspect of the invention, the Class-B amplifier is turned on or off in accordance with an operation mode of the liquid crystal device.

In this aspect, in order to reduce the power consumption as possibly as can be by using the B-class amplifier, the power source of the B-class amplifier is dynamically switched to ON or OFF based on the operation mode of the liquid crystal.

According to an eighth aspect of the invention, the regular voltage source includes a regular negative polarity voltage source that supplies the first voltage and a regular positive polarity voltage source that supplies the second voltage, the auxiliary voltage source includes an auxiliary negative polarity voltage source that supplies the third voltage and an auxiliary positive polarity voltage source that supplies the fourth voltage, a voltage supply terminal of the auxiliary negative polarity voltage source is connected to an output terminal of the regular negative polarity voltage source through a first bias resistor, and a voltage supply terminal of the auxiliary positive polarity voltage source is connected to an output terminal of the regular positive polarity voltage source through a second bias resistor.

In this aspect above, it is possible to stabilize the electric potential (DC bias) of the output terminal of the voltage source (auxiliary negative-polarity voltage source) for supplying the third voltage by connecting the output terminal of the voltage source (auxiliary negative-polarity voltage source) for supplying the third voltage (auxiliary negative-polarity voltage) to the output terminal of the regular negative-polarity voltage source for supplying the first voltage (regular negative-polarity voltage) though a bias resistor. Similarly, it is possible to stabilize the electric potential (DC bias) of the output terminal of the voltage source (auxiliary positive-polarity voltage source) for supplying the fourth voltage by connecting the output terminal of the voltage source (auxiliary positive-polarity voltage source) for supplying the fourth voltage (auxiliary positive-polarity voltage) to the output terminal of the regular positive-polarity voltage source for supplying the second voltage (regular positive-polarity voltage) though a bias resistor. Accordingly, it is easy to control the voltage variances of the third voltage and the fourth voltage within a predetermined width.

According to a ninth aspect of the invention, the regular voltage source includes a regular negative polarity voltage source that supplies the first voltage and a regular positive polarity voltage source that supplies the second voltage, the auxiliary voltage source includes an auxiliary negative polarity voltage source that supplies the third voltage and an auxiliary positive polarity voltage source that supplies the fourth voltage, a voltage supply terminal of the auxiliary negative polarity voltage source is connected to an output terminal of the regular negative polarity voltage source through a first limiter including a bi-directional diode, and a voltage supply terminal of the auxiliary positive polarity voltage source is connected to an output terminal of the regular positive polarity voltage source through a second limiter including a bi-directional diode.

In the aspect above, by using the bi-directional diode, the same advantages as can be acquired by using the bias resistor can be acquired.

According to a tenth aspect of the invention, the regular voltage source includes a regular negative polarity voltage source that supplies the first voltage and a regular positive polarity voltage source that supplies the second voltage, the auxiliary voltage source includes an auxiliary negative polarity voltage source that supplies the third voltage and an auxiliary positive polarity voltage source that supplies the fourth voltage, a voltage supply terminal of the auxiliary negative polarity voltage source is connected to an output terminal of the regular negative polarity voltage source through a first switch, and a voltage supply terminal of the auxiliary positive polarity voltage source is connected to an output terminal of the regular positive polarity voltage source through a second switch.

In the aspect above, the electric potentials (DC bias) of the output terminals of the voltage sources (auxiliary positive-polarity and negative-polarity voltage sources) for supplying the third voltage and the fourth voltage can be controlled to have a level equivalent to that of the output terminal of the regular voltage source in a speedy manner by turning on the first switch and the second switch, and accordingly, the electric potentials (DC bias) can be stabilized. The switch can be used alone or used together with the bias resistor. Since the resistance of the bias resistor is considerably high, a corresponding time is required for stabilizing the electric potentials (DC bias) in a case where the bias resistor is used alone. However, by using the switch together with the bias resistor, it is possible to stabilize the electric potentials (DC bias) of the output terminals of the voltage sources (auxiliary positive-polarity and negative-polarity voltage sources) for supplying the third voltage and the fourth voltage at a desired timing in a speedy manner.

According to an eleventh aspect of the invention, the first switch and the second switch are turned on for a predetermined time when the operation of the liquid crystal device is started.

In the aspect above, the electric potentials (DC bias) of the output terminals of the voltage sources (auxiliary positive-polarity and negative-polarity voltage sources) for supplying the third voltage and the fourth voltage can be stabilized in a speedy manner at a time when the operation of the liquid crystal device is initially started.

According to a twelfth aspect of the invention, the first switch and the second switch are turned on for a predetermined time at predetermined time intervals in a period when the total scanning lines are not selected.

In the aspect above, the switches can be periodically turned on at predetermined intervals, and the switches can be turned on in a period (for example, a blanking interval) other than an image display period. Accordingly, the electric potentials (DC bias) of the output terminals of the voltage sources (auxiliary positive-polarity and negative-polarity voltage sources) for supplying the third voltage and the fourth voltage can be stabilized continuously.

According to a thirteenth aspect of the invention, there is provided a control circuit including: a first substrate having a plurality of scanning lines, a plurality of data lines, a plurality of pixel electrodes disposed in correspondence with intersections of the plurality of scanning lines and the plurality of data lines, and common electrode disposed to face the pixel electrodes a second substrate disposed to face the first substrate a liquid crystal interposed between the first substrate and the second substrate a first voltage source used as a regular voltage source for supplying a first voltage that is a negative polarity regular common electrode voltage a second voltage source used as a regular voltage source for supplying a second voltage that is a positive polarity regular common electrode voltage a third voltage source used as an auxiliary voltage source for supplying a third voltage that is a negative polarity auxiliary common electrode voltage, which has a level equivalent to or approximately the same as that of the first voltage, to be applied to the common electrodes corresponding to pixels in the non selection period a fourth voltage source used as an auxiliary voltage source for supplying a fourth voltage that is a positive polarity auxiliary common electrode voltage, which has a level equivalent to or approximately the same as that of the second voltage, to be applied to the common electrodes corresponding to pixels in the selection period; and a switching circuit for selecting one from among the first voltage, the second voltage, the third voltage, and the fourth voltage and applying the selected voltage to the common electrodes.

In the aspect above, a control circuit, which is used for a liquid crystal device, using a new driving method of common oscillation inversion in which regular common electrode voltages (the first and second voltages) to be supplied to the common electrodes in the selection period of pixels and non-selection period common electrode voltages (the third and fourth voltages) to be supplied to the common electrodes in the non-selection period of pixels can be appropriately applied can be acquired.

According to a fourteenth aspect of the invention, there is provided an electronic apparatus having the above-described liquid crystal device.

In the aspect above, since deterioration of display quality due to crosstalk current can be suppressed, the image display capability of the electronic apparatus is improved, and thereby it is possible to implement a high-performance electronic apparatus.

According to a fifteenth aspect of the invention, there is provided a method of driving a liquid crystal device having a first substrate having a plurality of scanning lines, a plurality of data lines, a plurality of pixel electrodes disposed in correspondence with intersections of the plurality of scanning lines and the plurality of data lines, and common electrode disposed to face the pixel electrodes, a second substrate disposed to face the first substrate, and a liquid crystal interposed between the first substrate and the second substrate, the method including: supplying a first voltage as a negative polarity regular common electrode voltage to the common electrodes corresponding to pixel electrodes when the scanning lines have an active level and a positive polarity writing voltage is supplied to the pixel electrodes from the data lines supplying a second first voltage as a negative polarity auxiliary common electrode voltage which has a level equivalent to or almost the same as that of the first voltage and supplied from a voltage source other than the voltage source of the first voltage to the common electrodes when the scanning lines change to an inactive level supplying a third voltage as a positive polarity regular common electrode voltage to the common electrodes corresponding to pixel electrodes when the scanning lines have the active level and a negative polarity writing voltage is supplied to the pixel electrodes from the data lines; and supplying a fourth voltage as a positive polarity auxiliary common electrode voltage which has a level equivalent to or almost the same as that of the third voltage and supplied from a voltage source other than the voltage source of the third voltage to the common electrodes when the scanning lines change to an inactive level.

In the aspect above, a method of driving a liquid crystal device using a new driving type of common oscillation inversion in which regular common electrode voltages (the first and second voltages) to be supplied to the common electrodes in the selection period of pixels and non-selection period common electrode voltages (the third and fourth voltages) to be supplied to the common electrodes in the non-selection period of pixels can be appropriately applied can be implemented.

According to a sixteenth aspect of the invention, the common electrode is divided for each horizontal line and opposite polarity voltages are applied to the common electrodes located in adjacent rows in the fifteenth aspect of the invention.

In the aspect above, the effect of suppressing the flicker can be improved by inverting the polarities of voltages applied to adjacent common lines (common electrodes).

### BRIEF DESCRIPTION OF THE DRAWINGS

The invention will be described with reference to the accompanying drawings, wherein like numbers reference like elements.

FIG. 1 is a diagram showing an example of the whole configuration of a liquid crystal device according to an embodiment of the invention.

FIG. 2 is an enlarged plan view of a pixel part shown in FIG. 1.

FIG. 3 is a cross-sectional view of the pixel part of FIG. 2 taken along line A-A.

FIG. 4 is a block diagram showing the circuit configuration of a control circuit according to an embodiment of the invention.

FIG. 5 is a timing chart showing an example of the operation of the control circuit.

FIG. 6 is a timing chart illustrating the positive-polarity writing of the liquid crystal device.

FIG. 7 is a timing chart illustrating the negative polarity writing of the liquid crystal device.

FIG. 8 is a schematic diagram for describing crosstalk occurring through parasitic capacitance between data lines X and common lines Z.

FIG. 9 is a diagram showing a current path in the liquid crystal device shown in FIG. 8 in a case where current flows from the data line side to the common line side in accordance with a variance (rise) of the electric potential of the data line.

FIG. 10 is a diagram showing a current path in the liquid crystal device shown in FIG. 8 in a case where a current flows from the common line side to the data line side in accordance with a variance (drop) of the electric potential of the data line.

FIG. 11 is a diagram showing the configuration of featured major parts of a liquid crystal device according to an embodiment of the invention.

FIG. 12 is a diagram showing a detailed example of the configuration of a control circuit shown in FIG. 11.

FIG. 13 is a diagram for describing an advantage (advantage of reduction of crosstalk current from data lines to common lines) acquired from connecting the common lines in non-selection periods to an auxiliary voltage source according to an embodiment of the invention.

FIG. 14 is a diagram for describing an advantage (advantage of reduction of crosstalk current from the common lines to the data lines) acquired from connecting the common lines in the non-selection periods to the auxiliary voltage source according to an embodiment of the invention.

FIGS. 15A and 15B are waveform diagrams for describing the configurations of auxiliary common line voltage sources VSC1 and VSC2 according to an embodiment of the invention.

FIGS. 16A to 16C are diagrams for describing an example of the configuration of the Class-B amplifiers each having a dead zone.

FIG. 17 is a waveform diagram showing driving waveforms for parts of a liquid crystal device according to an embodiment of the invention for writing positive polarity.

FIG. 18 is a waveform diagram showing driving waveforms for parts of a liquid crystal device according to an embodiment of the invention for writing negative polarity.

FIG. 19 is a diagram showing a modified example of the circuit configuration of voltage source that generates common line voltages VCOML′ and VCOMH′ for the non-selection period according to an embodiment of the invention.

FIG. 20 is a diagram showing another modified example of the circuit configuration of the voltage source that generates common line voltages VCOML′ and VCOMH′ for the non-selection period according to an embodiment of the invention.

FIG. 21 is a diagram showing another modified example of the circuit configuration of a voltage source that generates common line voltages VCOML′ and VCOMH′ for the non-selection period according to an embodiment of the invention.

FIG. 22 is a diagram showing an example (simple example) of an auxiliary voltage source (a common line voltage source) for non-selected common lines according to an embodiment of the invention.

FIG. 23 is a diagram showing the whole configuration of a projector including a liquid crystal device according to an embodiment of the invention.

FIG. 24 is a perspective view showing the configuration of a personal computer including a liquid crystal device according to an embodiment of the invention.

FIG. 25 is a perspective view showing the configuration of a mobile terminal having a liquid crystal device according to an embodiment of the invention.

### DESCRIPTION OF EXEMPLARY EMBODIMENTS

Next, embodiments of the present invention will be described with reference to the accompanying drawings. The embodiments described below are not for the purpose of unreasonably limiting the scope of the invention defined by claims. Furthermore, it cannot be determined that all the constituent members described in the embodiments are essential as solving means of the invention.

In a description below, first, the basic configuration of an FFS liquid crystal capable of common oscillation polarity inversion will be described. Then, featured parts of the invention will be described.

In descriptions below, a liquid crystal device of an FFS (fringe field switching) mode will be described as an example. That is because the FFS-mode liquid crystal device is appropriate for implementing a polarity inversion method used in an embodiment of the present invention. However, the present invention is not limited thereto, and a liquid crystal device of an IPS (in-plane switching) mode can be used. The IPS-mode liquid crystal device is generally referred to as a traversal field-type liquid crystal, and the FFS-mode liquid crystal device is referred to as a fringing field switching-type liquid crystal or an oblique field-type liquid crystal. The IPS-mode liquid crystal device and the FFS-mode liquid crystal device are in common that traversal electric fields are used for alignment of liquid crystal molecules. In descriptions here, a traversal field-type liquid crystal includes the IPS-mode liquid crystal and the FFS-mode liquid crystal.

According to the present invention, a method (common oscillation inversion method) in which electric potentials of a common electrode and a pixel electrode are periodically inverted for a polarity inversion process performed for preventing image sticking is used. In addition, a method in which adjacent common electrodes are electrically separated from each other and common electric potentials having opposite polarities are given to common electrodes driven by odd common lines and common electrodes driven by even common lines is used.

In general liquid crystal devices (liquid crystal devices having a configuration in which a liquid crystal is interposed between a common electrode disposed on an opposing substrate and a pixel electrode disposed on a substrate located on a side opposite to the opposing substrate), the area of the common electrode is large, and accordingly, a time required for polarity inversion is long. In addition, since the common electrode is not divided, it is difficult to give common electric potentials of opposite polarities to the common electrodes driven by the odd common lines and the common electrodes driven by the even common lines.

Thus, in exemplary embodiments of the present invention described below, a traversal field-type liquid crystal (more particularly, an FFS-mode liquid crystal) in which the above-described polarity inversion control process can be easily performed is used. However, a general liquid crystal device may be used, as long as the common electrode thereof can be divided and polarities of the divided common electrodes can be individually controlled. In other words, the invention includes the general liquid crystal device having the above-described configuration.

### Whole Configuration and Basic Operation of FFS-Mode Liquid Crystal Device

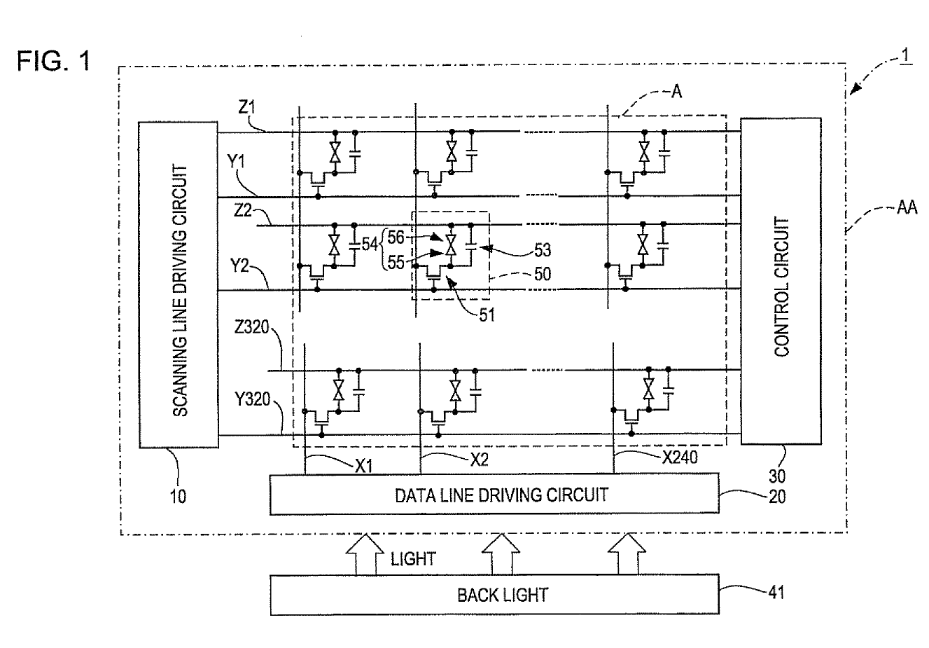

FIG. 1 is a diagram showing an example of the whole configuration of an FFS-mode liquid crystal device according to an embodiment of the invention. A common electrode can be represented as one signal line in the figure, and thus, in descriptions below, the common electrode will be referred to as a common line for the convenience of description. Thus, a common line is used as a synonym of a common electrode. Accordingly, for example, “a common line voltage” can be rephrased as “a common electrode voltage”, and both phrases are equivalent.

As shown in FIG. 1, the liquid crystal device 1 includes a liquid crystal panel AA and a backlight 41 that is disposed to face the liquid crystal panel AA so as to emit light. The liquid crystal device 1 performs transmissive display by using light emitted from the backlight 41.

The liquid crystal panel AA is configured to include: a display area A having a plurality of pixels 50; and a scanning line driving circuit 10, a data line driving circuit 20, and a control circuit 30 that are provided in the vicinity of the display area A so as to drive the pixels 50. The backlight 41 is provided in a bottom surface of the liquid crystal panel AA. In addition, the backlight 41 is formed using, for example, a cold cathode fluorescent tube (CCFL), an LED (light-emitting diode), or an electroluminescent (EL) device and supplies light to the pixels 50 of the liquid crystal panel AA.

Hereinafter, the configuration of the liquid crystal panel AA will be described in detail.

The liquid crystal panel AA includes 320 rows of scanning lines Y1 to Y320 and 320 rows of common lines Z1 to Z320 provided alternately with predetermined gaps therebetween and 240 rows of data lines X1 to x240 disposed to cross the scanning lines Y1 to Y320 and the common lines Z1 to Z320. A pixel 50 is disposed at an intersection of each scanning line Y and each data line X.

Each pixel 50 is configured to include a TFT 51, a pixel electrode 55, a common electrode 56 disposed to face the pixel electrode 55, and a storage capacitor 53 having one electrode connected to the common line Z and the other electrode connected to the pixel electrode 55. The pixel electrode 55 and the common electrode 56 form a pixel capacitor 54.

The common electrode 56 is provided separately for every horizontal line in correspondence with the scanning lines Y. Each one of the plurality of common electrodes 56 provided separately for every horizontal line is connected to a corresponding common line Z.

The scanning line Y is connected to a gate of the TFT 51, the data line X is connected to a source of the TFT 51, and the pixel electrode 55 and the other electrode of the storage capacitor 53 are connected to a drain of the TFT 51. Therefore, when a selection voltage is applied from the scanning line Y, the TFT 51 is turned on, and thereby the data line X, the pixel electrode 55, and the other electrode of the storage capacitor 53 are in an electrically conductive state.

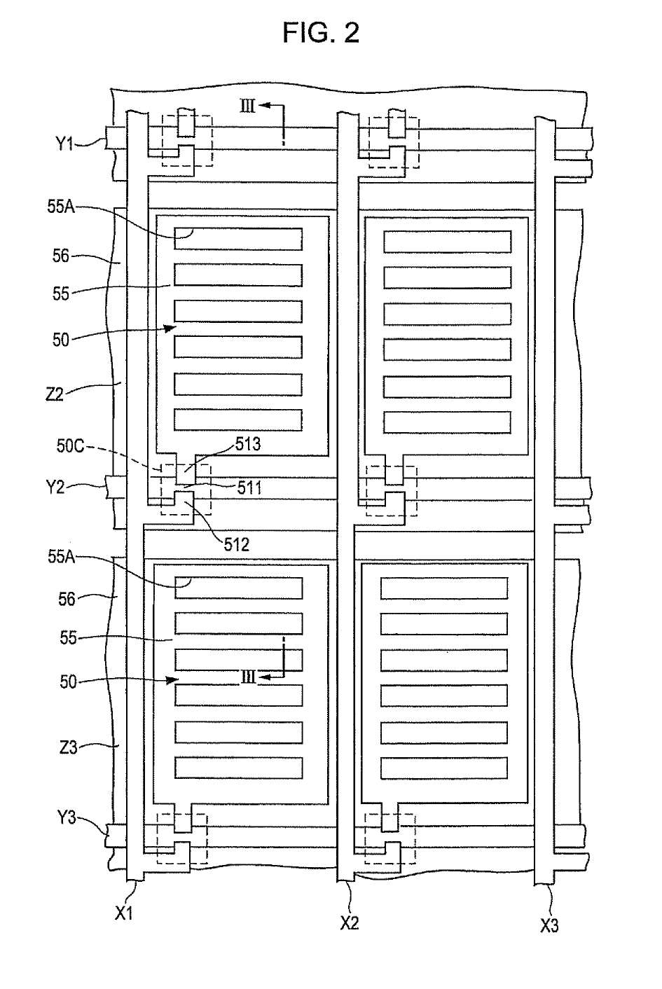

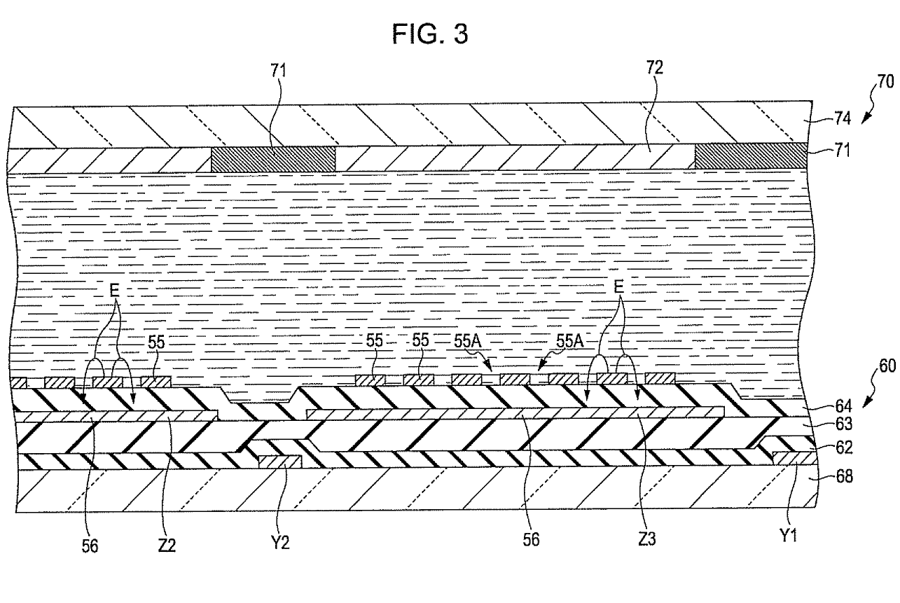

Next, the planar configuration and the cross-sectional configuration of a pixel part of the FFS-mode liquid crystal device shown in FIG. 1 will be described with reference to FIGS. 2 and 3.

FIG. 2 is an enlarged plan view of the FFS-mode pixel part shown in FIG. 1. FIG. 3 is a cross-sectional view of the pixel part of FIG. 2 taken along line A-A. As shown in FIG. 3, the liquid crystal panel AA includes an element substrate 60 having the plurality of pixel electrodes 55, an opposing substrate 70 disposed to face the element substrate 60, and a liquid crystal disposed between the element substrate 60 and the opposing substrate 70.

As shown in FIG. 2, in the element substrate 60, each pixel 50 is formed as a region surrounded by two adjacent scanning lines Y that are made of a conductive material and two adjacent data lines X that are made of a conductive material. In other words, each pixel 50 is partitioned by the scanning lines Y and the data lines X.

The TFT 51 is a reverse stagger-type amorphous silicon TFT, and a region 50C (portion surrounded by a dotted line in FIG. 2) in which the TFT 51 is formed is positioned near the intersection of the scanning line Y and the data line X.

First, the element substrate 60 will be described. The element substrate 60 has a glass substrate 68. On the glass substrate 68, a base insulating film (not shown) is formed over the entire surface of the element substrate 60 in order to prevent variation in characteristics of the TFT 51 from occurring due to surface roughness and contamination of the glass substrate 68.

On the base insulating film, the scanning line Y made of a conductive material is formed. The scanning line Y is disposed along the boundary between the adjacent pixels 50 and forms a gate electrode 511 of the TFT 51 in the vicinity of an intersection of the scanning line Y and the data line X. On the scanning line Y, the gate electrode 511, and the base insulating film, a gate insulating film 62 is formed over the entire surface of the element substrate 60.

In the region 50C on the gate insulating film 62 where the TFT 51 is formed, a semiconductor layer (not shown) made of amorphous silicon and an ohmic contact layer (not shown) made of N+ amorphous silicon are laminated to face the gate electrode 511. A source electrode 512 and a drain electrode 513 are laminated on the ohmic contact layer, and thereby an amorphous silicon TFT is formed.

The source electrode 512 is formed of the same conductive material as the data line X. In other words, the source electrode 512 is configured to protrude from the data line X. The data line X is disposed so as to cross the scanning line Y and the common line Z.

As described above, the gate insulating film 62 is formed on the scanning line Y and the data line X is formed on the gate insulating film 62. Accordingly, the data line X is insulated from the scanning line Y by the gate insulating film 62.

On the data line X, the source electrode 512, the drain electrode 513, and the gate insulating film 62, a first insulating film 63 is formed over the entire surface of the element substrate 60.

On the first insulating film 63, the common line Z made of a transparent conductive material, such as ITO (indium tin oxide) is formed. The common line Z is formed along the scanning line Y. In addition, the common line Z is formed integrally with the common electrode 56 that is separated for every horizontal line.

On the common line Z, the common electrode 56, and the first insulating film 63, a second insulating film 64 is formed over the entire surface of the element substrate 60.

On the second insulating film 64, the pixel electrode 55 made of a transparent conductive material such as ITO (indium tin oxide) is formed in a region facing the common electrode 56. The pixel electrode 55 is connected to the drain electrode 513 through contact holes (not shown) formed in the first insulating film 63 and the second insulating film 64.

In the pixel electrode 55, a plurality of slits 55A for generating a fringe field (electric field E) between the pixel electrodes 55 and the common electrode 56 are provided at predetermined gaps. In other words, the liquid crystal of the liquid crystal device 1 operates in the FFS mode.

On the pixel electrode 55 and the second insulating film 64, an alignment film (not shown) that is formed of an organic film, such as a polyimide layer, is formed over the entire surface of the element substrate 60.

Next, the opposing substrate 70 will be described.

The opposing substrate 70 has a glass substrate 74. At a position on the glass substrate 74 opposite the scanning line Y, a light shielding film 71 as a black matrix is formed. In addition, a color filter 72 is formed in a region on the glass substrate 74 excluding a region where the light shielding film 71 is formed.

On the light shielding film 71 and the color filter 72, an alignment film (not shown) is formed over the entire surface of the opposing substrate 70.

Referring back to FIG. 1, the scanning line driving circuit 10 supplies a selection voltage, which causes the TFTs 51 to be turned on, to the plurality of scanning lines Y in a sequential manner. For example, when the selection voltage is supplied to a scanning line Y, all the TFTs 51 connected to the scanning line Y are turned on. Accordingly, all the pixels 50 relating to the scanning line Y are selected.

The data line driving circuit 20 supplies an image signal to the data line X and writes an image voltage on the basis of the image signal into the pixel electrode 55 through the TFT 51 that is in the ON state.

Here, the data line driving circuit 20 alternately performs a positive-polarity writing process in which the data line driving circuit 20 supplies a positive-polarity image signal, of which an electric potential is higher than that of the voltage of the common electrode 56, to the data line X so as to write an image voltage on the basis of the positive-polarity image signal into the pixel electrode 55 and a negative-polarity writing process in which the data line driving circuit 20 supplies a negative-polarity image signal, of which an electric potential is lower than that of the voltage of the common electrode 56, to the data line X so as to write an image voltage on the basis of the negative-polarity image signal into the pixel electrode 55 for every horizontal line.

The control circuit 30 alternately supplies a voltage VCOML serving as a first voltage and a voltage VCOMH, which has an electric potential higher than that of the voltage VCOML, serving as a second voltage, to the common line Z.

The above-described liquid crystal device 1 operates as below. In other words, first, one between the voltage VCOML and the voltage VCOMH is selectively supplied from the control circuit 30 to the common line Z.

Specifically, the voltage VCOML and the voltage VCOMH are alternately supplied to each common line Z for every frame period. For example, when the voltage VCOML is supplied to a p-th row common line Zp (where p is an integer satisfying 1≦p≦320) for one frame period, the voltage VCOMH is supplied to the common line Zp for the next one frame period. On the other hand, when the voltage VCOMH is supplied to the common line Zp for one frame period, the voltage VCOML is supplied to the common line Zp for the next one frame period.

In addition, different voltages are supplied to the adjacent common lines Z. For example, when the voltage VCOML is supplied to the common line Zp for one frame period, the voltage VCOMH is supplied to a (p−1)-th row common line Z(p−1) and a (p+1)-th row common line Z(p+1) for the same one frame period. On the other hand, when the voltage VCOMH is supplied to the common line Zp for one frame period, the voltage VCOML is supplied to the common line Z(p−1) and the common line Z(p+1) for the same one frame period.

Then, the scanning line driving circuit 10 sequentially supplies the selection voltage to 320 rows of the scanning lines Y1 to Y320 to sequentially turn on all the TFTs 51 connected to each scanning line Y, and thereby all the pixels 50 relating to each scanning line Y are sequentially selected.

Next, in synchronization with the selection of the pixels 50, the data line driving circuit 20 alternately supplies the positive-polarity image signal and the negative-polarity image signal to the data line X for every horizontal line in accordance with the voltage of the common electrode 56.

Specifically, when the voltage VCOML is supplied to the common line Zp relating to the pixel 50 selected from among the 320 rows of common lines Z1 to Z320, the positive-polarity image signal is supplied to the data line X. On the other hand, when the voltage VCOMH is supplied to the common line Zp relating to the pixel 50 selected from among the 320 rows of the common lines Z1 to Z320, the negative-polarity image signal is supplied to the data line X.

Then, an image signal is supplied from the data line driving circuit 20 to all the pixels 50 selected by the scanning line driving circuit 10 through the data line X and the TFTs 51 that are in the ON state, and thereby an image voltage on the basis of the image signal is written into the pixel electrodes 55. Thus, a difference of electric potentials occurs between the pixel electrode 55 and the common electrode 56, and accordingly, a driving voltage is applied to the liquid crystal.

When a driving voltage is applied to the liquid crystal, the alignment or order of the liquid crystal changes, and whereby light emitted from the back light 41 and transmitted through the liquid crystal changes. As the changed light transmits through color filters, gray scale display is performed.

In addition, due to the storage capacitor 53, the driving voltage applied to liquid crystal is maintained for a period of time that is three orders of magnitude longer than a period of time for which the image voltage is written.

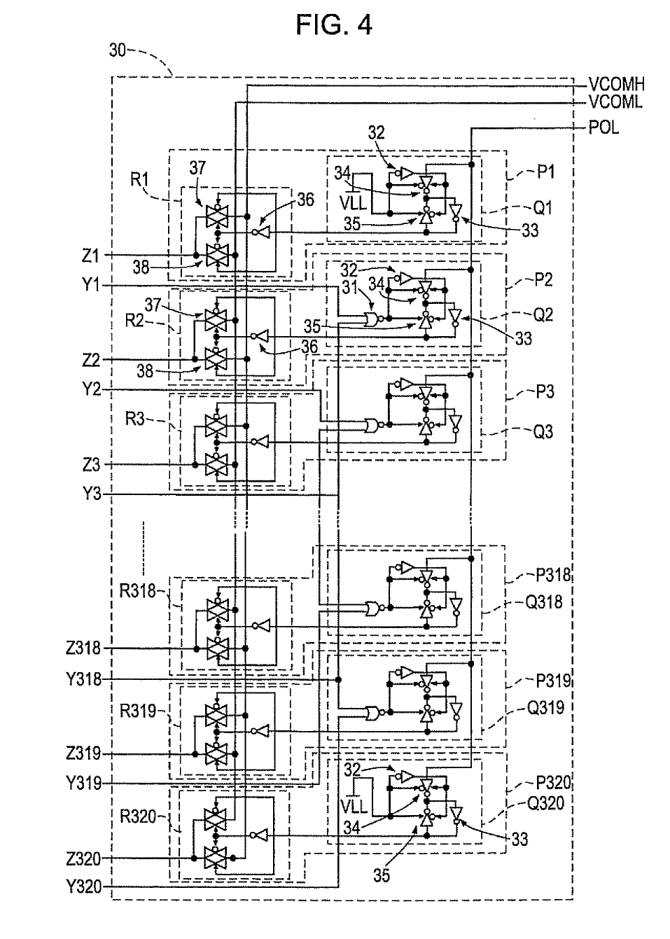

FIG. 4 is a block diagram of the control circuit 30. The control circuit 30 includes 320 unit control circuits P1 to P320 corresponding to the 320 rows of the scanning lines Y1 to Y320. The voltage VCOML, the voltage VCOMH, and a polarity signal POL for selecting one between the voltage VCOML and the voltage VCOMH are supplied to each unit control circuit P.

The unit control circuit P includes a latch circuit Q that maintains the polarity signal POL and a selection circuit R that selectively outputs one between the voltage VCOML and the voltage VCOMH in accordance with the polarity signal POL.

The latch circuit Q may be largely divided into two types based on a method of maintaining the polarity signal POL. One type is a latch circuit Q1 provided in correspondence with the first row scanning line Y1 and a latch circuit Q320 provided in correspondence with the 320-th row scanning line Y320. The other type is latch circuits Q2 to Q319 other than the above-described latch circuits Q1 and Q320.

First, the latch circuits Q2 to Q319 will be described. A latch circuit Qq (where q is an integer satisfying 2≦q≦319) provided in correspondence with a q-th row scanning line Yq includes a NOT-OR operation circuit (hereinafter, referred to as a ‘NOR circuit’) 31, a first inverter 32, a second inverter 33, a first clocked inverter 34, and a second clocked inverter 35.

A (q−1)-th scanning line Y(q−1) and a (q+1)-th scanning line Y(q+1) are connected to two input terminals of the NOR circuit 31, respectively. An output terminal of the NOR circuit 31 is connected to an input terminal of the first inverter 32, an inverting input control terminal of the first clocked inverter 34, and a non-inverting input control terminal of the second clocked inverter 35.

An output terminal of the first inverter 32 is connected to a non-inverting input control terminal of the first clocked inverter 34 and an inverting input control terminal of the second clocked inverter 35.

The polarity signal POL is input to an input terminal of the first clocked inverter 34. An output terminal of the first clocked inverter 34 is connected to an input terminal of the second inverter 33.

An input terminal of the second clocked inverter 35 is connected to an output terminal of the second inverter 33, and an output terminal of the second clocked inverter 35 is connected to the input terminal of the second inverter 33.

The above-described latch circuit Qq operates as below. When a selection voltage is supplied to at least one of the scanning line Y(q−1) and the scanning line Y(p+1), the NOR circuit 31 included in the latch circuit Qq outputs an L-level signal. The L-level signal is input to the inverting input control terminal of the first clocked inverter 34, inverted by the first inverter 32, and then input as an H-level signal to a non-inverting input terminal of the first clocked inverter 34. Accordingly, the first clocked inverter 34 is turned so as to invert the polarity signal POL and outputs the inverted polarity signal. The polarity signal POL that is inverted and output from the first clocked inverter 34 is inverted by the second inverter 33 and is then output from the second inverter 33.

As described above, when a selection voltage is supplied to at least one of the scanning line Y(q−1) and the scanning line Y(p+1) from the scanning line driving circuit, the latch circuit Qp receives the polarity signal POT.

On the other hand, when a selection voltage is not supplied to both the scanning line Y(q−1) and the scanning line Y(p+1), the NOR circuit 31 included in the latch circuit Qq outputs an H-level signal. The H-level signal is input to the non-inverting input control terminal of the second clocked inverter 35, is inverted by the first inverter 32, and is then input as an L-level signal to an inverting input terminal of the second clocked inverter 35. Accordingly, the second clocked inverter 35 is turned on so as to invert the polarity signal POL, which is output from the second inverter 33, and output the inverted polarity signal. The polarity signal POL that is inverted and output from the second clocked inverter 35 is input again to the second inverter 33.

As described above, when a selection voltage is not supplied to both the scanning line Y(q−1) and the scanning line Y(p+1) from the scanning line driving circuit, the latch circuit Qp maintains the polarity signal POL, which has been already received, through the second inverter 33 and the second clocked inverter 35.

Next, the latch circuits Q1 and Q320 will be described.

As compared with the latch circuit Qq described above, each of the latch circuits Q1 and Q320 includes a low electric potential power source VLL that outputs an L-level signal instead of the NOR circuit 31. The other configurations are the same as those of the latch circuit Qq described above.

The latch circuits Q1 and Q320 operate as below. An L-level signal is continuously output from the low electric potential power source VLL. The L-level signal is input to the inverting input control terminal of the first clocked inverter 34, and the L-level signal is inverted by the first inverter 32 and is then input as an H-level signal to the non-inverting input control terminal of the first clocked inverter 34. Accordingly, the first clocked inverter 34 is always in the ON state, and thereby the first clocked inverter 34 inverts the polarity signal POL all the time and outputs the inverted polarity signal. The polarity signal POL that is inverted and output from the first clocked inverter 34 is inverted by the second inverter 33 and is then output from the second inverter 33. As described above, the latch circuits Q1 and Q320 receives the polarity signal POL all the time.

The selection circuit R includes an inverter 36, a first transfer gate 37, and a second transfer gate 38.

An input terminal of the inverter 36 is connected to an output terminal of the second inverter 33 included in the latch circuit Q, and an output terminal of the inverter 36 is connected to a non-inverting input control terminal of the first transfer gate 37 and an inverting input control terminal of the second transfer gate 38.

An inverting input control terminal of the first transfer gate 37 is connected to an output terminal of the second inverter 33 included in the latch circuit Q, and an output terminal of the first transfer gate 37 is connected with the common line Z.

In addition, the voltage VCOMH is input to an input terminal of the first transfer gate 37 included in the selection circuit R provided in correspondence with the odd row scanning lines Y. On the other hand, the voltage VCOML is input to an input terminal of the first transfer gate 37 included in the selection circuit R provided in correspondence with the even row scanning lines Y.

A non-inverting input control terminal of the second transfer gate 38 is connected to the output terminal of the second inverter 33 included in the latch circuit Q, and an output terminal of the second transfer gate 38 is connected with the common line Z.

In addition, the voltage VCOML is input to an input terminal of the second transfer gate 38 included in the selection circuit R provided in correspondence with the odd row scanning lines Y. On the other hand, the voltage VCOMH is input to an input terminal of the second transfer gate 38 included in the selection circuit R provided in correspondence with the even row scanning lines Y.

The selection circuit R described above operates as follows. When the L-level polarity signal POL is output from the second inverter 33 included in the latch circuit Q, the L-level polarity signal POL is input to the inverting input control terminal of the first transfer gate 37, and, the L-level polarity signal POL is inverted by the inverter 36 and is then input as the H-level polarity signal POL to the non-inverting input control terminal of the first transfer gate 37. Accordingly, the first transfer gate 37 is turned on.

When the first transfer gate 37 that is turned on is included in the selection circuit R provided in correspondence with the odd row scanning line Y, the voltage VCOMH is output to the common line Z. On the other hand, when the first transfer gate 37 that is turned on is included in the selection circuit R provided in correspondence with the even row scanning line Y, the voltage VCOML is output to the common line Z.

On the other hand, when the H-level polarity signal POL is output from the second inverter 33 included in the latch circuit Q, the H-level polarity signal POL is input to the non-inverting input control terminal of the second transfer gate 38, and the H-level polarity signal POL is inverted by the inverter 36 and is then input as the L-level polarity signal POL to the inverting input control terminal of the second transfer gate 38. Accordingly, the second transfer gate 38 is turned on.

When the second transfer gate 38 that is turned on is included in the selection circuit R provided in correspondence with the odd row scanning line Y, the voltage VCOML is output to the common line Z. On the other hand, when the second transfer gate 38 that is turned on is included in the selection circuit R provided in correspondence with the even row scanning line Y, the voltage VCOMH is output to the common line Z.

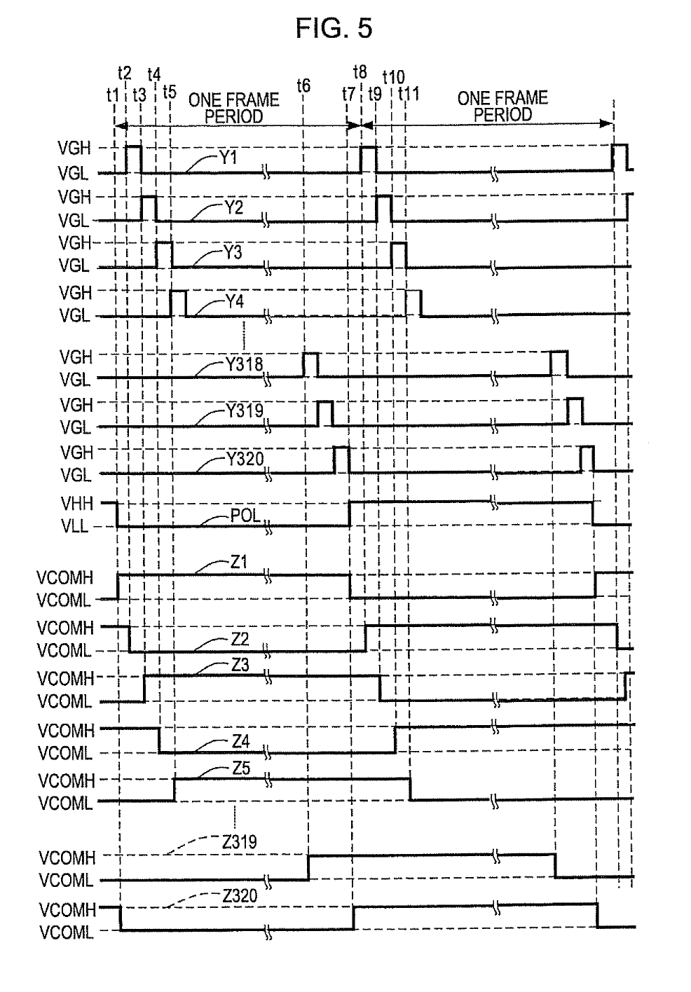

Next, an operation of the control circuit 30 including the latch circuit Q and the selection circuit R will be described with reference to FIG. 5. FIG. 5 is a timing chart of the control circuit 30.

First, at time t1, the polarity signal POL is set as a voltage VLL, and accordingly, the polarity signal POL has an ‘L’ level. Then, the unit control circuits P1 and P320 receive the L-level polarity signal POL through the latch circuits Q1 and Q320 that continuously receive the polarity signal POL and output the voltage VCOMH and the voltage VCOML through the selection circuit R1 and R320, respectively. Accordingly, the common line Z1 connected to the unit control circuit P1 has the voltage VCOMH, and the common line Z320 connected to the unit control circuit P320 has the voltage VCOML. In addition, a voltage VGH is 8 V and a voltage VGL is −1 V.

Then, at time t2, a selection voltage is supplied from the scanning line driving circuit 10 to a first row scanning line Y1, and accordingly, a voltage of the scanning line Y1 changes to the voltage VGH. Then, the unit control circuit P2 provided in correspondence with a scanning line Y2 which is adjacent to the scanning line Y1 receives the L-level polarity signal POL through the latch circuit Q2 and outputs the voltage VCOML through the selection circuit R2. Accordingly, the common line Z2 connected to the unit control circuit P2 has the voltage VCOML.

Then, at time t3, the scanning line driving circuit 10 stops supplying the selection voltage to the scanning line Y1, and thereby a voltage of the scanning line Y1 changes to the voltage VGL.

At the same time, the selection voltage is supplied from the scanning line driving circuit 10 to the second row scanning line Y2, and accordingly, a voltage of the scanning line Y2 changes to the voltage VGH. Then, the unit control circuit P3 provided in correspondence with a scanning line Y3 which is adjacent to the scanning line Y2 receives the L-level polarity signal POL through the latch circuit Q3 and outputs the voltage VCOMH through the selection circuit R3. Accordingly, the common line Z3 connected to the unit control circuit P3 has the voltage VCOMH.

Then, at time t4, the scanning line driving circuit 10 stops supplying the selection voltage to the scanning line Y2, and accordingly a voltage of the scanning line Y2 changes to the voltage VGL.

At the same time, the selection voltage is supplied from the scanning line driving circuit 10 to the third row scanning line Y3, and accordingly a voltage of the scanning line Y3 changes to the voltage VGH. Then, the unit control circuit P4 provided in correspondence with a scanning line Y4 adjacent to the scanning line Y3 receives the L-level polarity signal POL through the latch circuit Q4 and outputs the voltage VCOML through the selection circuit R4. Accordingly, the common line Z4 connected to the unit control circuit P4 has the voltage VCOML.

In addition, the unit control circuit P2 provided in correspondence with the scanning line Y2 adjacent to the scanning line Y3 receives the L-level polarity signal POL through the latch circuit Q2 and outputs the voltage VCOML through the selection circuit R2. Accordingly, the common line Z2 connected to the unit control circuit P2 has the voltage VCOML.

Then, at time t5, the scanning line driving circuit 10 stops supplying the selection voltage to the scanning line Y3, and accordingly a voltage of the scanning line Y3 changes to the voltage VOL.

At the same time, the selection voltage is supplied from the scanning line driving circuit 10 to the fourth row scanning line Y4, and accordingly a voltage of the scanning line Y4 changes to the voltage VGH. Then, the unit control circuit P5 provided in correspondence with a scanning line Y5 adjacent to the scanning line Y4 receives the L-level polarity signal POL through the latch circuit Q5 and outputs the voltage VCOMH through the selection circuit R5. Accordingly, the common line Z5 connected to the unit control circuit P5 has the voltage VCOMH.

In addition, the unit control circuit P3 provided in correspondence with the scanning line Y3 adjacent to the scanning line Y4 receives the L-level polarity signal POL through the latch circuit Q3 and outputs the voltage VCOMH through the selection circuit R3. Accordingly, the common line Z3 connected to the unit control circuit P3 has the voltage VCOMH.

Thereafter, when the selection voltage is supplied from the scanning line driving circuit 10 to the odd row scanning line Y (excluding the first row scanning line Y1), an operation described above at time t4 is performed. In addition, when the selection voltage is supplied from the scanning line driving circuit 10 to the even row scanning line Y (excluding the 320-th row scanning line Y320), an operation described above at time t5 is performed.

Then, at time t7, the scanning line driving circuit 10 stops supplying the selection voltage to the 320-th row scanning line Y320, and accordingly a voltage of the scanning line Y320 changes to the voltage VGL.

At the same time, the polarity signal POL changes to have a voltage VHH, and accordingly the polarity signal POL has an ‘H’ level. Then, the unit control circuits P1 and P320 receive the H-level polarity signal POL through the latch circuits Q1 and Q320 that continuously receive the polarity signal POL and output the voltage VCOML and the voltage VCOMH through the selection circuit R1 and R320, respectively. Accordingly, the common line Z1 connected to the unit control circuit P1 has voltage VCOML, and the common line Z320 connected to the unit control circuit P320 has the voltage VCOMH.

Then, at time t8, the selection voltage is supplied from the scanning line driving circuit 10 to the first row scanning line Y1, and accordingly the voltage of the scanning line Y1 changes to the voltage VGH, in the same manner used at time t2. Then, the unit control circuit P2 outputs the voltage VCOMH, and accordingly, the common line Z2 connected to the unit control circuit P2 has the voltage VCOMH.

Then, at time t9, the scanning line driving circuit 10 stops supplying the selection voltage the scanning line Y1, and accordingly the voltage of the scanning line Y1 changes to the voltage VGL, in the same manner used at time t3.

At the same time, the selection voltage is supplied from the scanning line driving circuit 10 to the scanning line Y2, and accordingly the voltage of the scanning line Y2 changes to the voltage VGH, in the same manner used at time t3. Then, the unit control circuit P3 outputs the voltage VCOML, and accordingly, the common line Z3 connected to the unit control circuit P3 has the voltage VCOML.

Then, at time t10, the scanning line driving circuit 10 stops supplying the selection voltage the scanning line Y2, and accordingly the voltage of the scanning line Y2 changes to the voltage VGL, in the same manner used at time t4.

At the same time, the selection voltage is supplied from the scanning line driving circuit 10 to the scanning line Y3, and accordingly the voltage of the scanning line Y3 changes to the voltage VGH, in the same manner used at time t4. Then, the unit control circuit P4 outputs the voltage VCOMH, and accordingly, the common line Z4 connected to the unit control circuit P4 has the voltage VCOMH.

In addition, the unit control circuit P2 outputs the voltage VCOMH, and accordingly, the common line Z2 connected to the unit control circuit P2 has the voltage VCOMH, in the same manner used at time t4.

Then, at time t11, the scanning line driving circuit 10 stops supplying the selection voltage the scanning line Y3, and accordingly the voltage of the scanning line Y3 changes to the voltage VGL, in the same manner used at time t5. At the same time, the selection voltage is supplied from the scanning line driving circuit 10 to the scanning line Y4, and accordingly the voltage of the scanning line Y4 changes to the voltage VGH, in the same manner used at time t5. Then, the unit control circuit P5 outputs the voltage VCOML, and accordingly, the common line Z5 connected to the unit control circuit P5 has the voltage VCOML.

In addition, the unit control circuit P3 outputs the voltage VCOML, and accordingly, the common line Z3 connected to the unit control circuit P3 has the voltage VCOML, in the same manner used at time t5.

Thereafter, when the selection voltage is supplied from the scanning line driving circuit 10 to the odd row scanning line Y (excluding the scanning line Y1), the above described operation performed at time t10 is performed. In addition, when the selection voltage is supplied from the scanning line driving circuit 10 to the even row scanning line Y (excluding the scanning line Y320), the above-described operation performed at time t11 is performed.

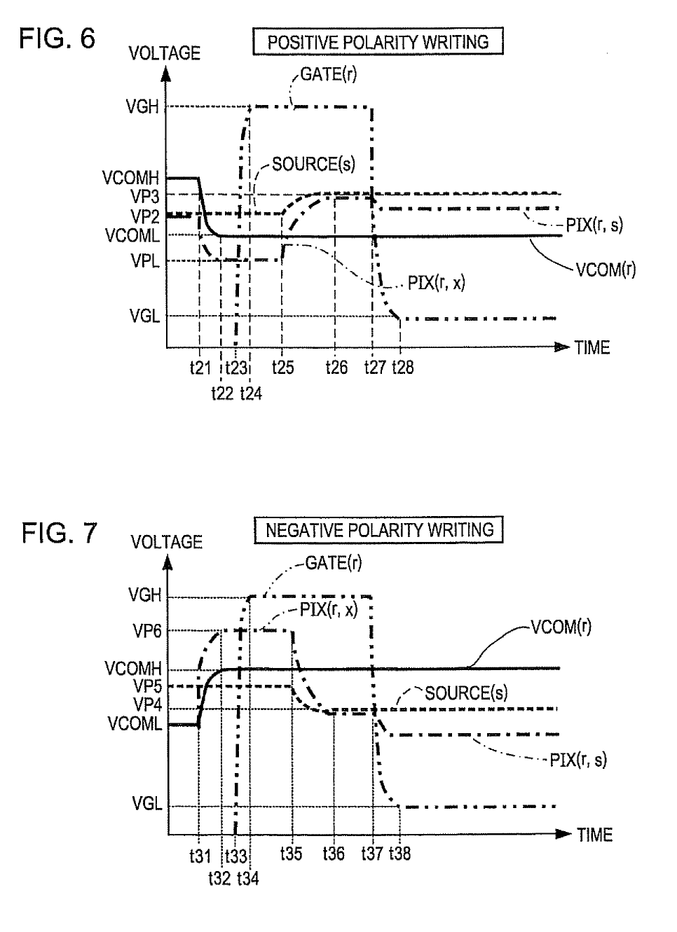

Hereinafter, the operation of the liquid crystal device 1 having the above-described control circuit 30 will be described with reference to FIGS. 6 and 7.

FIG. 6 is a timing chart illustrating the positive-polarity writing of the liquid crystal device 1. FIG. 7 is a timing chart illustrating the negative-polarity writing of the liquid crystal device 1.

In FIGS. 6 and 7, GATE(r) indicates a voltage of an r-th (where, “r” is an integer satisfying 1≦r≦320) row scanning line among 320 rows of scanning lines, and SOURCE(s) indicates a voltage of an s-th (where, ‘s’ is an integer satisfying 1≦S≦240) column data line Xs among 240 columns of data lines X. In addition, PIX(r, s) indicates a voltage of the pixel electrode 55 which is included in the pixel 50 of an r-th row and an s-th column provided in correspondence with an intersection of an r-th row scanning line Yr and an s-th column data line Xs. In addition, VCOM(r) indicates a voltage of the common electrode 56 connected to an r-th row common line Zr.

First, the positive-polarity writing of the liquid crystal device 1 will be described with reference to FIG. 6.

At time t21, the control circuit 30 supplies the voltage VCOML to the common line Zr. Then, a voltage VCOM(r) of the common electrode 56 connected to the common line Zr drops slowly and then reaches the voltage VCOML at time t22.

When the voltage VCOM(r) of the common electrode 56 connected to the common line Zr drops, the voltage PIX(r, s) of the pixel electrode 55 included in the pixel 50 corresponding to the r-th row and the s-th column drops so as to maintain an electric potential difference between the voltage VCOM(r) and the voltage PIX(r, s). Then, the voltage PIX(r, s) of the pixel electrode 55 included in the pixel 50 corresponding to the r-th row and the s-th column drops slowly and then reaches a voltage VP1 at time t22.

At time t23, the scanning line driving circuit 10 supplies the selection voltage to the scanning line Yr. Then, the voltage GATE(r) of the scanning line Yr rises and then reaches a voltage VGH at time t24. As a result, all TFTs 51 connected to the scanning line Yr are turned on.

At time t25, the data line driving circuit 20 supplies a positive-polarity image signal to the data line Xs. Then, the voltage SOURCE(s) of the data line Xs rises slowly and then reaches a voltage VP3 at time t26.

The voltage SOURCE(s) of the data line Xs is written, as an image voltage on the basis of the positive-polarity image signal, into the pixel electrode 55 included in the pixel 50 of the r-th row and the s-th column through the TFT 51 that is in the ON state and is connected to the scanning line Yr. Accordingly, the voltage PIX(r, s) of the pixel electrode 55 included in the pixel 50 of the r-th row and the s-th column drops slowly and then reaches the voltage VP3, which has the same potential level as the voltage SOURCE(s) of the data line Xs, at time t26.

At time t27, the scanning line driving circuit 10 stops supplying the selection voltage to the scanning line Yr. Then, the voltage GATE(r) of the scanning line Yr drops and then reaches a voltage VGL at time t28. As a result, all TFTs 51 connected to the scanning line Yr are turned off.

Next, the negative-polarity writing of the liquid crystal device 1 will be described with reference to FIG. 7. At time t31, the control circuit 30 supplies the voltage VCOMH to the common line Zr. Then, the voltage VCOM(r) of the common electrode 56 connected to the common line zr rises gradually and then reaches the voltage VCOMH at time t32.

When the voltage VCOM(r) of the common electrode 56 connected to the common line Zr rises, the voltage PIX(r, s) of the pixel electrode 55 included in the pixel 50 of the r-th row and s-th column rises so as to maintain an electric potential difference between the voltage VCOM(r) and the voltage PIX(r, s). Accordingly, the voltage PIX(r, s) of the pixel electrode 55 included in the pixel 50 of the r-th row and the s-th column rises gradually and then reaches a voltage VP6 at time t32.

At time t33, the scanning line driving circuit 10 supplies the selection voltage to the scanning line Yr. Then, the voltage GATE(r) of the scanning line Yr rises and then reaches a voltage VGH at time t34. As a result, all TFTs 51 connected to the scanning line Yr are turned on.

At time t35, the data line driving circuit 20 supplies a negative-polarity image signal to the data line Xs. Then, the voltage SOURCE(s) of the data line Xs drops slowly and then reaches a voltage VP4 at time t36.

The voltage SOURCE(s) of the data line Xs is written, as an image voltage on the basis of the negative-polarity image signal, into the pixel electrode 55 included in the pixel 50 of the r-th row and the s-th column through the TFT 51 that is in the ON state and is connected to the scanning line Yr. Accordingly, the voltage PIX(r, s) of the pixel electrode 55 included in the pixel 50 of the r-th row and the s-th column drops slowly and then reaches the voltage VP4, which has the same electric potential level as the voltage SOURCE(s) of the data line Xs, at time t36.

At time t37, the scanning line driving circuit 10 stops supplying the selection voltage to the scanning line Yr. Then, the voltage GATE(r) of the scanning line Yr drops and then reaches a voltage VGL at time t38. As a result, all TFTs 51 connected to the scanning line Yr are turned off.

As described above, in the liquid crystal device shown in FIG. 1, after the voltage level of the common electrode 56 becomes voltage VCOML by supplying voltage VCOML to the common line Z, a positive polarity image signal is supplied to the data line X, and thereby a positive polarity image voltage is written into the pixel electrode 55. In addition, after the voltage level of the common electrode 56 becomes voltage VCOMH by supplying voltage VCOMH to the common line Z, a negative polarity image signal is supplied to the data line X, and thereby a negative polarity image voltage is written into the pixel electrode 55. Accordingly, a method (common oscillation inversion method) of periodically inverting electric potentials of the common electrode (common line) and the pixel electrode for a polarity inversion process performed for preventing image sticking of the liquid crystal can be implemented in the liquid crystal device shown in FIG. 1.

### Review of Crosstalk Current and Featured Configuration and Operation of Liquid Crystal Device According to Embodiment of Present Invention

In the above-described liquid crystal device, although common oscillation inversion drive is implemented, crosstalk occurs due to parasitic capacitance intervening between the data line X and the common line Z. When an unnecessary charge/discharge current flows through the parasitic capacitance at a time when the data line X is driven, the power consumption increases correspondingly thereto. Accordingly, there is room left for improvement in view of reduction of the power consumption.

In addition, the voltage source (regular amplifier) that supplies voltage to the common lines takes a load of the whole crosstalk current flowing through the parasitic capacitance. Thus, the load of the regular amplifier increases, which may be one reason for occurrence of variations in the voltage levels supplied to the common lines. Accordingly, there is also room left for improvement in this viewpoint.

In consideration of the above-described problems, according to an embodiment of the invention, the above-described liquid crystal device is further improved so as to reduce the effect of the crosstalk due to the parasitic capacitance. Hereinafter, a detailed description will be followed with reference to the accompanying drawings.

Description of Crosstalk through Parasitic Capacitance Between Data Line X and Common Line Z

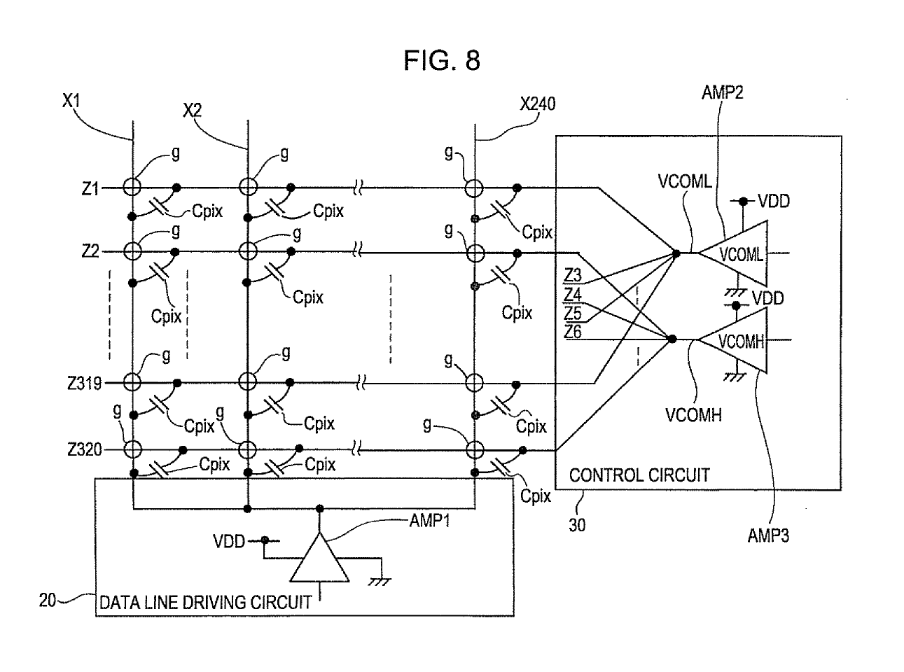

FIG. 8 is a schematic diagram for describing crosstalk occurring through the parasitic capacitance between the data lines X and the common lines Z. In FIG. 8, to a part common to that in the above-described diagrams, a same reference symbol is attached. This also applies to the following diagrams.

In FIG. 8, at intersections g of the data lines X1 to X240 and the common lines Z1 to Z320, parasitic capacitance is formed. In other words, between the data lines X and the common lines, an insulation film (for example, the insulation film 64 shown in FIG. 3) is interposed. Thus, parasitic capacitors Cpix each having the data line X as one electrode and the common line Z as the other electrode are formed.

Here, a state that the whole pixels of the liquid crystal device shown in FIG. 8 are turned on will be considered. This state may be considered as a state in which the data lines X1 and X240 are simultaneously driven by a data line driving amplifier AMP1 of the data line driving circuit 20 and the common lines Z1 to Z320 are simultaneously driven by common line driving regular amplifiers AMPS and AMP3 included in the control circuit 30. While the common line driving regular amplifier AMP2 is an amplifier used for generating the low-level common line voltage VCOML, the common line driving regular amplifier AMP3 is an amplifier used for generating the high-level common line voltage VCOMH.

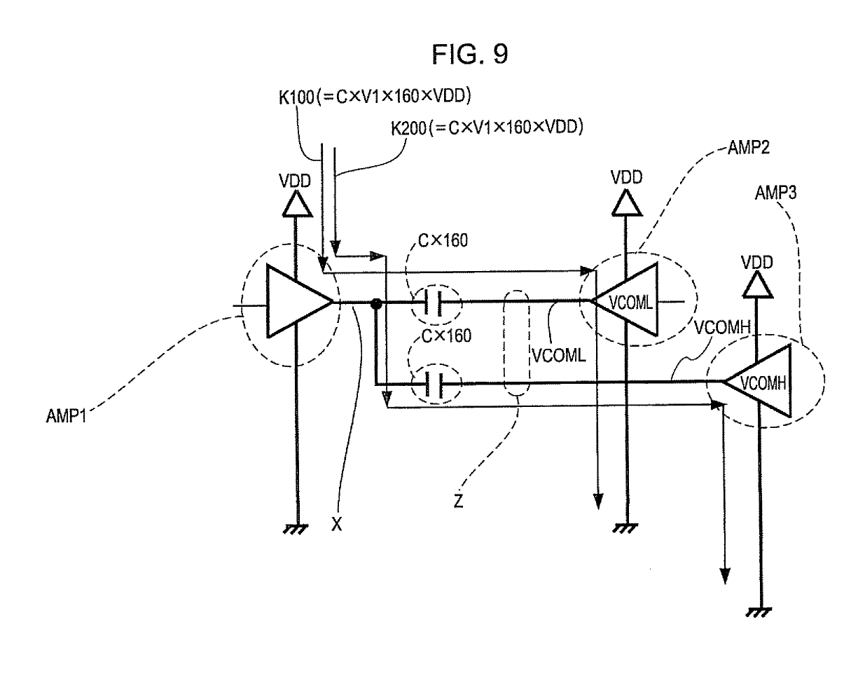

The crosstalk occurring in the liquid crystal device shown in FIG. 8 will now be described in detail. FIG. 9 is a diagram showing a current path in the liquid crystal device shown in FIG. 8 in a case where the current flows from the data line side to the common line side in accordance with a variance (rise) of the electric potential of the data line.

As described above, there are 320 common lines. To 160 common lines (for example, odd-th common lines) that are half of the total common lines, a high-level common line voltage VCOMH is applied, and, to 160 common lines (for example, even-th common lines) that are the other half of the total common lines, a high-level common line voltage VCOML is applied. When the whole parasitic capacitance parasitic on one common line Z is represented by C, the total parasitic capacitance of the 160 common lines is “C×160”.

Accordingly, as shown in FIG. 9, unnecessary transient currents are flown from the data line X to the common line Z through two current routes K100 and K200 that are formed via parasitic capacitance of “160×C”.

Here, when the width of a variance of the voltage level of the data line is represented by V1, energy (amount of work) consumed by a transient current in the current route K100 is “C×V1×160×VDD”. Similarly, energy (amount of work) consumed by a transient current in the current route K200 is “C×V1×160×VDD”. Consequently, a total of the consumed energy (amount of work) is “C×V1×320×VDD”. Here, VDD represents the source voltage level.

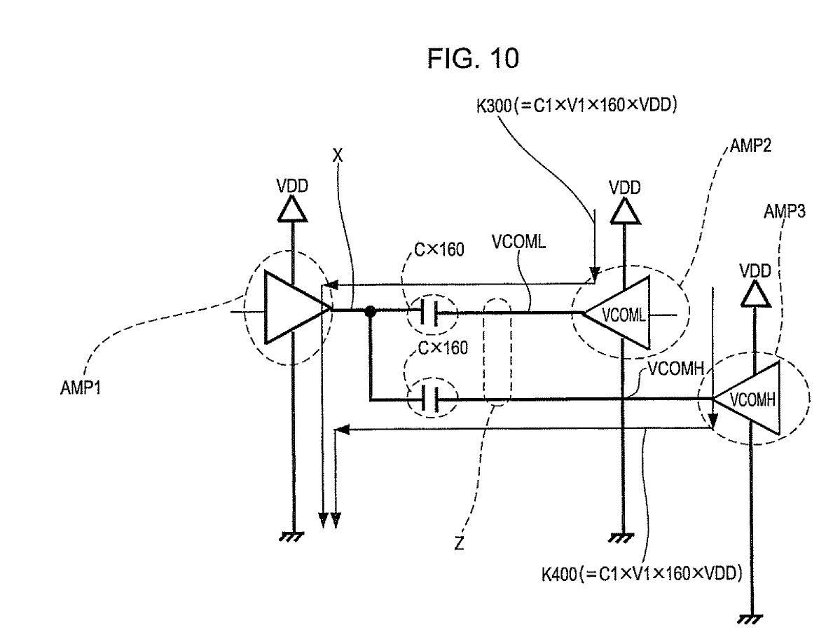

FIG. 10 is a diagram showing a current path in the liquid crystal device shown in FIG. 8 in a case where a current flows from the common line side to the data line side in accordance with a variance (drop) of the electric potential of the data line. As shown in the figure, like in FIG. 9, two transient current routes K300 and K400 are formed.

Here, when the width of a variance of the voltage level of the data line is represented by V1, energy (amount of work) consumed by a transient current in the current route K300 is “C×V1×160×VDD”. Similarly, energy (amount of work) consumed by a transient current in the current route K400 is “C×V1×160×VDD”. Consequently, a total of the consumed energy (amount of work) is “C×V1×320×VDD”.

In other words, the consumed energy (amount of work) in FIGS. 8 and 9 is “C×V1×320×VDD”, and energy corresponding to 320 common lines is unnecessarily consumed.

In addition, the voltage source (regular amplifier) that supplies voltage to the common lines takes a load of the whole crosstalk current flowing through the parasitic capacitance. Thus, the load of the regular amplifier increases, which may be one reason for occurrence of variations in the voltage levels supplied to the common lines.

### Basic Configuration According to Embodiment of Present Invention for Reducing Effect of Crosstalk

As a method of preventing the effect of crosstalk, as can be seen in examples of general configurations, a method of setting floating electric potentials to non-selected pixels may be considered. In such a case, a current path is removed, and accordingly, an extra current does not flow. However, since the electric potentials are floating (undetermined), it is inevitable that instability of pixel voltages increases.

Thus, according to an embodiment of the invention, the common lines for non-selected pixels are not floating, and are connected to an auxiliary voltage source having a simple configuration capable of reducing power consumption.

In other words, a new technique in which a common line voltage source (a regular amplifier) used during selection periods of pixels and a common line voltage source (an auxiliary voltage source that generates the same voltage level as that of the regular amplifier) used during non-selection periods of pixels are separately provided and connection targets of the common lines are switched in accordance with whether pixels connected to the common lines are during selection periods or non-selection periods is employed.

During selection periods of pixels, in order to write pixel voltages (gray scale voltages) into the pixels precisely, it is needed to control the electric potentials of the common lines with high precision. However, after a writing operation for each pixel is completed and the transfer switch of the pixel is turned off, the voltage level of the pixel is stably maintained by the storage capacitor 53 (having sufficiently large capacitance), and a control process for the electric potential of the common line with precision as high as that required for writing a voltage into the pixel is not needed during this period. In other words, even in a case where the electric potential of the common line changes minutely, it is thought that there is no effect on the pixel voltage that is stabilized by the storage capacitor 53.

On the basis of the above-described findings, when each pixel connected to a common line is completely switched from a selection period to a non-selection period, the connection target of the common line is switched to the auxiliary voltage source having the simple configuration correspondingly. Accordingly, the load of the regular amplifier that drives the common lines is reduced, and it is possible to provide voltage levels to the common lines with high precision in the selection period. At the same time, it is possible to reduce power consumption due to transient currents that flows through the parasitic capacitance.

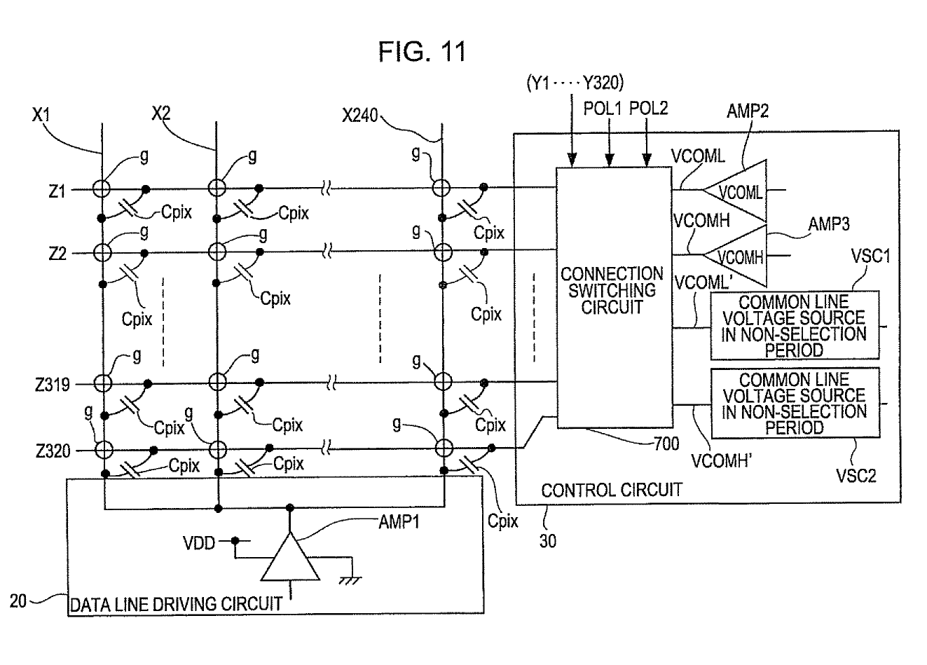

FIG. 11 is a diagram showing an overview of the configuration of a liquid crystal device according to an embodiment of the invention. A difference between configurations shown in FIGS. 11 and 8 is the configuration of the control circuit 30.

In other words, in FIG. 11, a common line voltage source (an auxiliary voltage source) VSC1 that supplies the low-level common line voltage VCOML during a non-selection period of each pixel is disposed in addition to the regular amplifier (a regular voltage source) AMP2 that supplies the low-level common line voltage VCOML during a selection period of each pixel.

Similarly, a common line voltage source (an auxiliary voltage source) VSC2 that supplies the high-level common line voltage VCOMH during a non-selection period of each pixel is disposed in addition to the regular amplifier (a regular voltage source) AMP3 that supplies the high-level common line voltage VCOMH during a selection period of each pixel.

In addition, a connection switching circuit 700 for switching the voltage source that becomes the connection target of each common line in accordance with selection (active state)/non-selection (inactive state) of the common lines Z1 to Z320 is provided.

To the connection switching circuit 700, voltages of the scanning lines Y1 to Y320 and a plurality of polarity signals POL1 and POL2 are input. The connection switching circuit 700 dynamically selects the voltage sources AMP2, AMP3, VSC1, and VSC2 that become the connection targets of the common lines Z1 to Z320 by using the input signals as control signals.

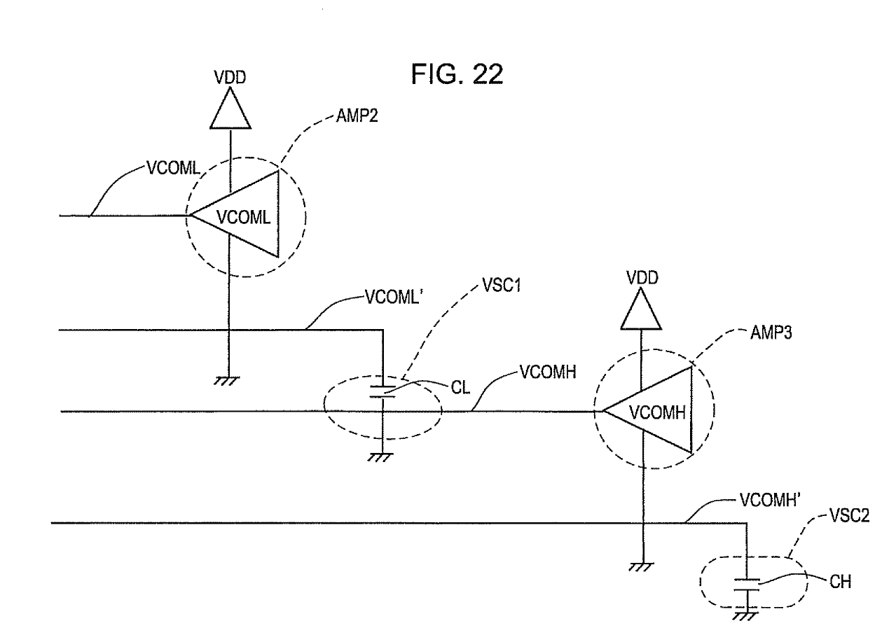

FIG. 22 is a circuit diagram showing an example (an example of a simple configuration) of the auxiliary voltage source (the common line voltage source) for non-selected common lines. As shown in FIG. 22, the auxiliary voltage supply sources (the common line voltage sources) VSC1 and VSC2 for the non-selected common lines, for example, are constituted by capacitors CL and CH having large capacitance.

The capacitors CL and CH, for example, are configured to have capacitance equal to or larger than “C×1600”, (10 times “C×160” shown in FIGS. 9 and 10), where C is the total parasitic capacitance parasite on one common line.

When discharging stored charges, the capacitors CL and CH serve as simplified voltage sources (current sources). Generally, when crosstalk occurs through the parasitic capacitance C (Cpix), a transient current is supplied from one between the regular amplifiers AMP2 and AMP3, and accordingly, there is power consumption.

However, in a case where the capacitors CL and CH are disposed as shown in FIG. 22 and voltages VCOML′ and VCOMH′ having voltage levels corresponding to the low-level common line voltage VCOML and the high-level common line voltage VCOMH are configured to be supplied to each common line during the non-selection period by using the capacitors CL and CH as simplified voltage sources, when crosstalk occurs, the capacitors CL and CH become the voltage sources (current sources), and whereby currents flow due to discharge of the stored charges.

As described above, the voltage levels of the auxiliary common line voltages VCOML′ and VCOMH′ corresponding to the non-selected pixels are set to be in correspondence with the voltage levels of the regular common line voltages VCOML and VCOMH.

In other words, the auxiliary common line voltages VCOML′ and VCOMH′ corresponding to the non-selected pixels are set to be equivalent to or approximately equal to the regular common line voltages VCOML and VCOMH.

The currents charging the capacitors CL and CH are transient currents (crosstalk currents) flowing from the data lines X to the common line Z side through the parasitic capacitance C (Cpix). When the transient currents (crosstalk currents) flow from the common lines z to the data lines X through the parasitic capacitance C (Cpix), only charges (resultant charges charged by the crosstalk currents) stored in the capacitors CL and Ch are discharged, and thereby substantial power consumption becomes zero.

In addition, since voltages are supplied to the common lines in non-selection periods from capacitors CL and CH serving as auxiliary voltage sources VSC1 and VSC2, the regular voltage sources (the regular amplifiers AMP2 and AMP3) supply voltages to the common lines only in the selection periods. Accordingly, the drive load of the regular voltage sources (the regular amplifiers AMP2 and AMP3) decreases, and whereby it is possible to supply voltages with high precision through the common lines in the selection periods.

The capacitors CL and CH repeats charge and discharge in accordance with a crosstalk current accompanied with a voltage change in a data line corresponding to image display in the pixel part of the liquid crystal device. Since the charge/discharge current is in proportion to the voltage change in the data line including the direction thereof, it is apparent that the integral of the charge/discharge current for a considerable time becomes zero (since the voltage of the data line cannot get out of a range of data amplitude VS, the integral of the voltage change in the data line is within the range of ±VS, and accordingly, as the time interval is set to be longer, the average current becomes closer to zero). Even in a worst case, when a time interval of 2V (where V is a vertical synchronization period) is taken, the integral of the charge/discharge current becomes zero, based on the alternating current principle of driving the liquid crystal.

Thus, it is though that there is not any particular problem in using the capacitors CL and CH as primary sources of charges for the common line (common electrode) in the non-selection period (that is, the capacitors CL and CH sufficiently work as primary voltage sources). Accordingly, marked reduction of power consumption of the liquid crystal device performing a common oscillation inversion driving process can be achieved.

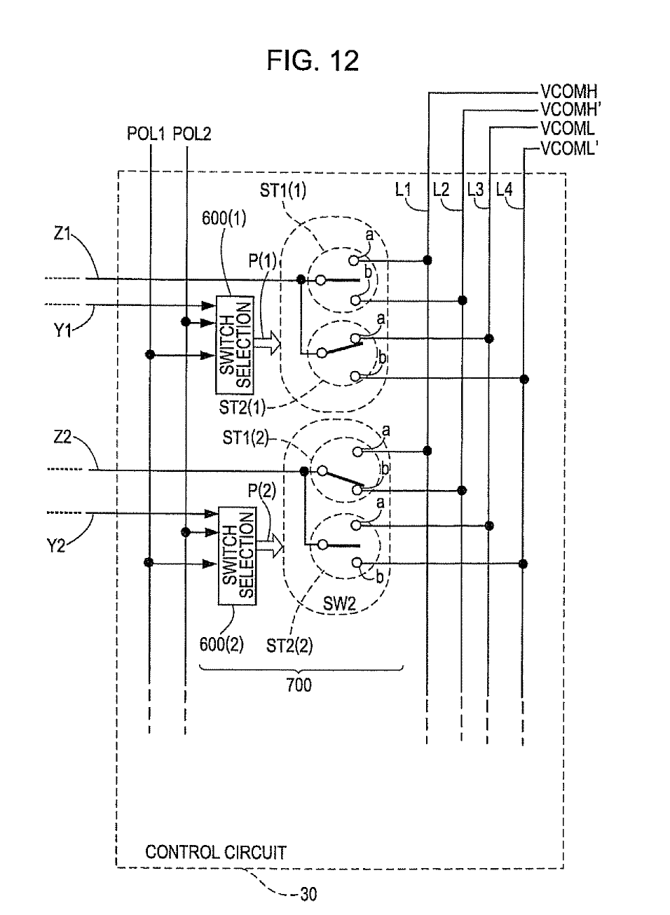

FIG. 12 is a diagram showing a detailed example of the configuration of the control circuit 30 shown in FIG. 11. The voltage supply process for the common lines which is performed by the control circuit 30 shown in FIG. 12 is basically the same as that shown in FIGS. 6 and 7, the operation of the control circuit 30 is basically the same as that shown in FIG. 5, and the circuit configuration of the control circuit 30 is basically the same as that shown in FIG. 4.

In the voltage supply process shown in FIGS. 6 and 7, both the low-level common line voltage VCOML and the high-level common line voltage VCOMH are supplied from the regular amplifiers AMP2 and AMP3 regardless whether the common lines are in the selection period or the non-selection period. However, here, it is needed that the voltage supply process from the regular amplifiers AMP2 and AMP3 is performed only for the common lines in the selection period and the voltage supply process for the common lines in the non-selection period is performed by the auxiliary voltage sources VSC1 and VSC2.

The control circuit 30 shown in FIG. 12 has a connection switching circuit 700 for switching voltage sources that become the connection targets of the common lines depending on whether the common lines are in the selection period or the non-selection period. The connection switching circuit 700 has a plurality of switching circuits SW1 and SW2 to SW320.

The switching circuit SW1 has two switching elements ST1(1) and ST2(1). The switching circuit SW1 selects one from among the regular high-level and low-level common line voltages VCOMH and VCOML for the common lines in the selection periods and the auxiliary high-level and low-level common line voltages VCOMH and VCOML′ for the common lines in the non-selection periods, by using the switching elements ST1(1) and ST2(1).

The switching control process for two switching elements ST1(1) and ST2(1) included in the switching circuit SW1 is performed by a switching selection circuit 600(1). This switching selection circuit 600(1) generates a switching control signal P(1) based on the voltage level of the scanning line Y1 and two polarity signals POL1 and POL2, and switching of the two switching elements ST1(1) and ST2(1) are performed in accordance with this switching control signal P(1). The switching control processes of other switching circuits SW2 to SW320 are performed in the same manner.

### Basic Operation of Liquid Crystal Device According to Embodiment of Present Invention

A liquid crystal device (the whole configuration thereof is the same as shown in FIG. 1) according to an embodiment of the invention performs featured operations as below based on the function of the control circuit 30 shown in FIG. 12.

The liquid crystal device 1 according to an embodiment of the invention having the whole configuration shown in FIG. 1 selectively supplies one between the low-level common line voltage VCOML and the high-level common line voltage VCOMH to common lines Zn corresponding to scanning lines Yn that have a selection voltage level supplied from the control circuit 30.

Then, during a period from a time when the scanning line Yn has the non-selection voltage to a time when the scanning line Yn has the selection voltage, when the low-level common line voltage VCOML has been supplied to a common line, the low-level common line voltage VCOML′ is supplied to the common line from the auxiliary voltage source VSC1. On the other hand, when the high-level common line voltage VCOMH has been supplied to a common line, the high-level common line voltage VCOMH′ is supplied to the common line from the auxiliary voltage source VSC2 during that period.

When considering a period during which the scanning line Yn has the selection voltage level, the voltage VCOML and the voltage VCOMH are alternately supplied to each common line Zn for each frame period. In addition, different voltage levels of VCOML and VCOMH are supplied to adjacent common lines Z during a period when corresponding scanning lines have the selection voltage levels.

As described above, the control circuit 30 is configured to supply each common line Z one from among the voltage VCOML used as a first voltage, the voltage VCOMH used as a second voltage having an electric potential higher than that of the voltage VCOML, the voltage VCOML′ having an almost same voltage level as the voltage VCOML, and the voltage VCOMH′ having an almost same voltage level as the voltage VCOMH.

### Advantage of Connecting Common Lines in Non-Selection Period to Auxiliary Voltage Source

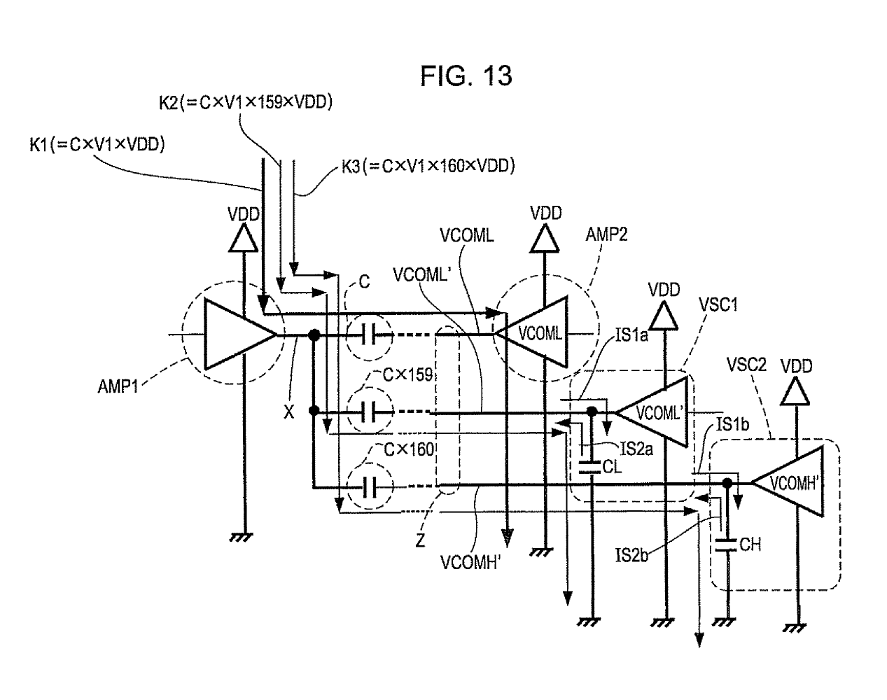

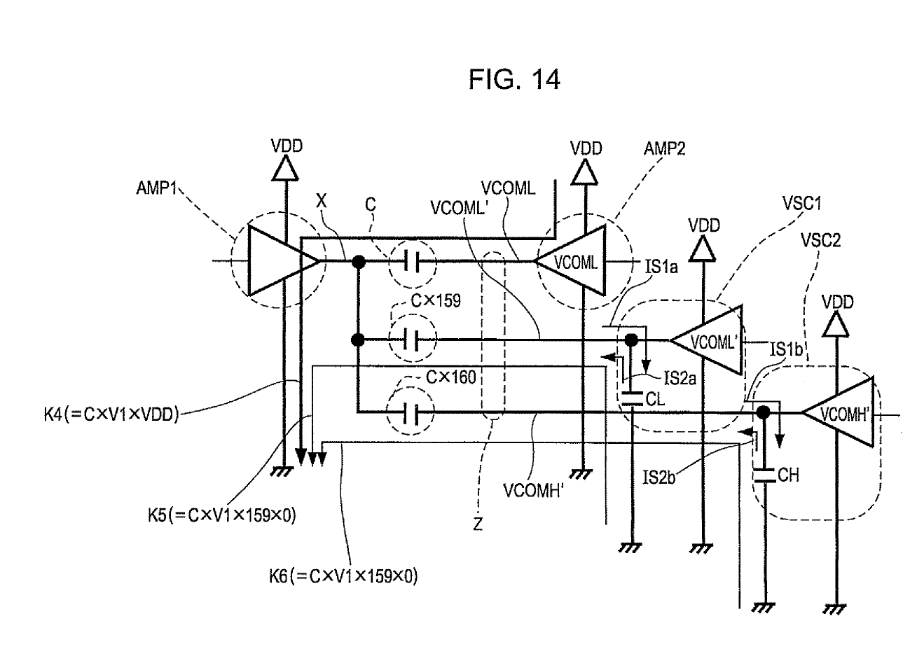

FIG. 13 is a diagram for describing an advantage (advantage of reduction of crosstalk currents from the data lines to the common lines) acquired from connecting the common lines in the non-selection periods to the auxiliary voltage source. Similarly, FIG. 14 is a diagram for describing an advantage (advantage of reduction of crosstalk currents from the common lines to the data lines) acquired from connecting the common lines in the non-selection periods to the auxiliary voltage source.

As shown in FIGS. 13 and 14, the voltage source VSC1 supplying the voltage VCOML, is constituted by a capacitor CL and an auxiliary amplifier (VCOML′ amplifier) having a dead zone that is used for limiting the width of the variance of the voltage level of the capacitor CL.

Similarly, the voltage source VSC2 supplying the voltage VCOMH′ is constituted by a capacitor CH and an auxiliary amplifier (VCOMH′ amplifier) having a dead zone that is used for limiting the width of the variance of the voltage level of the capacitor CH.

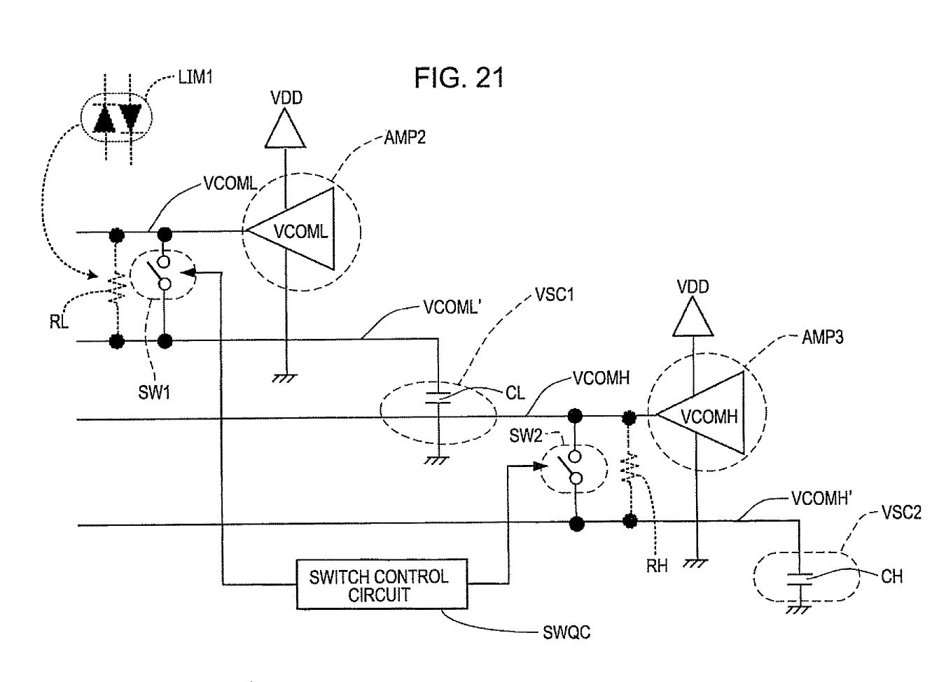

As described with reference to FIG. 21, although the voltage sources VSC1 and VSC2 may be basically configured by only the capacitors CL and CH, generated voltage levels become unstable in such a case. Accordingly, as shown in FIGS. 13 and 14, the auxiliary amplifiers (the VCOML′ amplifier and the VCOMH′ amplifier) that are used for limiting the widths of variances of the voltage levels so as to prevent marked changes of voltage levels of the capacitors CL and CH are dispose.

The VCOML′ amplifier and the VCOMH′ amplifier are Class-B amplifiers having dead zones. When each one of the capacitors CL and CH generates voltage having a level within an allowed range, a transistor disposed on the high-level voltage source side of the output terminal and a transistor disposed on the low-level voltage source side are all turned off, and the output terminal is in a high-impedance state, and thereby the amplifiers do not participate in the voltage supply process. However, when the voltages of the capacitors CL and CH run off the allowed range, the VCOML′ amplifier or the VCOMH′ amplifier operates for regulating the voltages of the capacitors CL and CH.

Thus, the auxiliary voltage sources VSC1 and VSC2 shown in FIGS. 13 and 14 have voltage variations suppressed within a predetermined range, and thereby reliability thereof is improved, compared to a case where a configuration having only the capacitor CL or CH shown in FIG. 21 is used. The technology for arranging a dead zone in a Class-B amplifier will be described later in detail with reference to FIG. 18.

In FIG. 13, since voltages VCOML and VCOMH become references for writing voltages of the liquid crystal, voltage levels thereof with high precision are required. Thus, the regular amplifiers AMP2 and AMP3 are configured by amplifiers (Class-AB amplifiers) having small dead zones as possibly as can be.

Here, the paths of the crosstalk currents shown in FIG. 13 will be described. Here, a liquid crystal panel of QVGA (240×RGB×320) will be considered. In FIG. 13, the parasitic capacitance between the data line X and the common line Z for each horizontal line is represented by C. In addition, it is assumed that the capacitance of the capacitors CL and CH is configured such that voltage variances of VCOMH′ and VCOML′ according to the charge/discharge currents (crosstalk currents) through the parasitic capacitance C which are generated in accordance with a variance of the data line X are set to be within the dead zones of the amplifiers VCOMH′ and VCOML′.

In FIG. 13, as the paths of the crosstalk currents, there are three paths K1 to 13. K1 represents the path of a crosstalk current flowing from the data line toward one common line in a selection period. K2 represents the path of a crosstalk current flowing toward other 159 common lines belonging to the group of the selected common line. K3 represents the path of a crosstalk current flowing toward 160 common lines belonging to a group (that is, a group of common lines driven in an opposite polarity) different from the group of the selected common line. Hereinafter, a detailed description thereof will be followed.

As described above, one of common lines Z for which a corresponding scanning line Y has a selection voltage is connected to the VCOMH or VCOML (since the cases are the same, a case where VCOML is connected is drawn in FIG. 13).

159 common lines among the remaining common lines are connected to the amplifier VCOML′, and 160 different common lines are connected to the amplifier VCOMH′.

In this state, movement of charges during a period when the voltage level of the data line X rises will be considered. Here, the voltage change of the data line is represented by V1.

For the one selected common line, charges are moved toward the ground through a path K1 constituted by a voltage source VDD, a data line driving amplifier AMP1, a parasitic capacitance C, and a regular amplifier AMP2. In this case, the consumed energy (the amount of work) becomes “C×V1×VDD”.

For the other 159 lines, the energy (the amount of work) consumed due to a crosstalk current flowing through a path K2 becomes “C×V1×159×VDD”.

In addition, for the different 160 common lines driven in the opposite polarity, the energy (the amount of work) consumed due to a crosstalk current flowing through a path K3 becomes “C×V1×160×VDD”.

The power consumption shown in FIG. 13 is substantially the same as that shown in FIG. 9. However, in FIG. 13, the crosstalk currents IS1a and IS1b flowing through the paths K2 and K3 charge the capacitors CL and CH which constitute the auxiliary voltage sources VSC1 and VSC2. Accordingly, when a crosstalk current flows from a common line toward the data line thereafter, these capacitors CL and CH serve as substantial voltage sources.

Next, movement of charges during a period when the voltage level of the data line X drops will be considered. Here, the voltage change of the data line is represented by V1.

In this case, as shown in FIG. 14, there are paths K4 to K6 of crosstalk currents. In the path K4, charges are moved toward the negative side (ground) of the power source through the power source VDD, the regular amplifier AMP2 of VCOML, the parasitic capacitance C, and the data line driving amplifier AMP1. In this case, consumed energy (the amount of work) is “C×V1×VDD”.

In a path K5, from the ground, charges are moved toward the ground through the capacitor CL, the parasitic capacitance C, and the data line driving amplifier AMP1. However, since both electric potentials of the start point and the end point are the ground (GND), the consumed energy becomes zero (C×V1×159×0=0), and there is no energy consumption.

In addition, in path K6, from the ground, charges are moved toward the ground through the capacitor CH, the parasitic capacitance C, and the data line driving amplifier AMP1. However, since both electric potentials of the start point and the end point are the ground (GND), the consumed energy becomes zero (C×V1×160×0=0), and there is no energy consumption.

Therefore, the total amount of energy consumed in the configuration shown in FIGS. 13 and 14 becomes “C×V1×161×VDD”. On the other hand, the total amount of energy consumed in the configuration shown in FIGS. 9 and 10 becomes “C×V1×320×VDD”. Accordingly, in the configuration shown in FIGS. 13 and 14, the power consumption due to crosstalk currents is reduced by about half the power consumption in the configuration shown in FIGS. 9 and 10.

In addition, as can be known from FIGS. 13 and 14, the regular amplifier AMP2 or AMP3 driving the common lines handles only one common line that is selected, and the auxiliary common line voltage source VSC1 or VSC2 handles the other 319 common lines. Therefore, the load of the regular amplifier AMP2 or AMP3 driving the common lines is reduced, and a voltage with high precision can be supplied to the selected common line.

### Configuration of Auxiliary Common Line Voltage Source VSC1 or VSC2

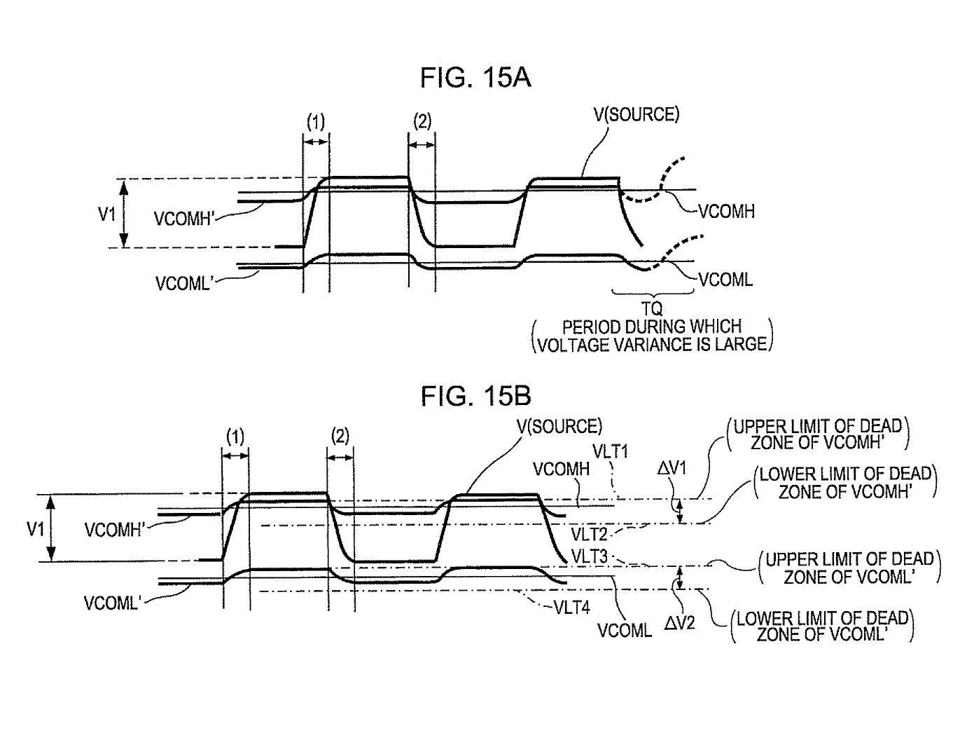

FIGS. 15A and 15B are waveform diagrams for describing the configuration of the auxiliary common line voltage source VSC1 or VSC2.

FIGS. 15A and 15B are diagrams for describing variances of VCOMH′ and VCOML′ which are supplied from the regular common line voltage sources VCOMH and VCOML and the auxiliary voltage sources VSC1 and VSC2 during a period when the voltage level of the data line X rises by V1 (period (1)) and a period when the voltage level of the data line X drops by V1 (period (2)).

As shown in FIGS. 15A and 15B, since the regular common line voltages VCOMH and VCOML are generated by Class-AB amplifiers AMP2 and AMP3 having high precision, the voltage levels thereof do not vary at all. On the other hand, since the auxiliary common line voltage source VSC1 or VSC2 is basically constituted by the capacitors CL and CH as shown in FIG. 21, VCOMH′ and VCOML′ slight vary due to the effect of the change in the electric potential of the data line X.

When the auxiliary common line voltage source VSC1 or VSC2 is configured only by the capacitors CL and CH as shown in FIG. 21, as shown in a period TQ positioned on the right end of FIG. 15A, there may be a case where VCOMH′ and VCOML′ markedly vary. In such a case, the pixel voltage becomes unstable, and whereby there may be an effect on the precision for a writing process.

Thus, it is preferable that the widths of variances of the voltage levels of VCOMH′ and VCOML′ are configured to be limited by adding a unit for limiting the voltage variances other than the capacitors CL and CH in the auxiliary voltage sources VSC1 and VSC2.

FIG. 15B shows voltage waveforms in a case where upper and lower limits of VCOMH′ and VCOML′ are defined by adding a unit for limiting the voltage variances other than the capacitors CL and CH in the auxiliary voltage sources VSC1 and VSC2.

As shown in the figure, the upper limit of VCOMH′ is VLT1, the lower limit of VCOMH′ is VLT2, and the width of the variance thereof is suppressed to be ΔV1.

Similarly, the upper limit of VCOML′ is VLT3, the lower limit of VCOML′ is VLT4, and the width of the variance thereof is suppressed to be ΔV2.

The limitation of the upper and lower limits of VCOMH′ and VCOML′, as described with reference to FIGS. 13 and 14, is achieved by disposing Class-B amplifiers (the VCOMH′ amplifier and the VCOML′ amplifier) each having a dead zone and adjusting the widths of the dead zones to the above-described allowed widths ΔV1 and ΔV2 of voltages.

Described the other way, the capacitance of the capacitors CH and CL is determined to be adjusted to the dead zones of Class-B amplifiers. In such a case, the capacitance of the capacitors CH and CL, for example, may be determined as below.

The parasitic capacitance between the data line X and the common line Z for each horizontal line is represented by C, the total number of lines is represented by n, and the amount of maximum change of the voltage level (for example, an absolute value of a difference between writing voltages for positive polarity ON and negative polarity ON) of the data line X is represented by V1.

The width of voltage levels of dead zones of Class-B amplifiers for VCOMH′ and VCOML′ are represented by ΔVCOMH′ and ΔVCOML′. In addition, the capacitance of each capacitor CH and CL is represented by CH and CL.

In such a case, “ΔVCOMH′>C×(n/2)×V1/(CH·ΔVCOML′)>C×n/2×V1/CL)” is to be satisfied, and accordingly, the capacitance of each capacitor is determined as below.

CH>C×n/2×V1/VCOMH′

CL>C×n/2×V1/VCOML′

The above-described method of setting the capacitance is a merely an example, and the invention is not limited thereto.

### Example of Circuit Configuration of Class-B Amplifier Having a Dead Zone

Next, an example of circuit configurations of Class-B amplifiers (the VCOML′ amplifier and the VCOMH′ amplifier constituting VSC1 and VSC2 shown in FIGS. 13 and 14) each having a dead zone will now be described.

The Class-B amplifiers have dead zones and do not participate in the voltage supply process in a case where the above-described voltages of the capacitors CL and CH are within the allowed range. On the other hand, when the above-described voltages of the capacitors CL and CH are beyond the allowed range, the Class-B amplifiers operate so as to regulate the voltage variances thereof. In other words, the Class-B amplifiers serve as voltage limiters for the capacitors CL and CH, and thereby a decrease in reliability can be prevented by controlling the voltage variances of VCOML′ and VCOMH′ within the allowed range.

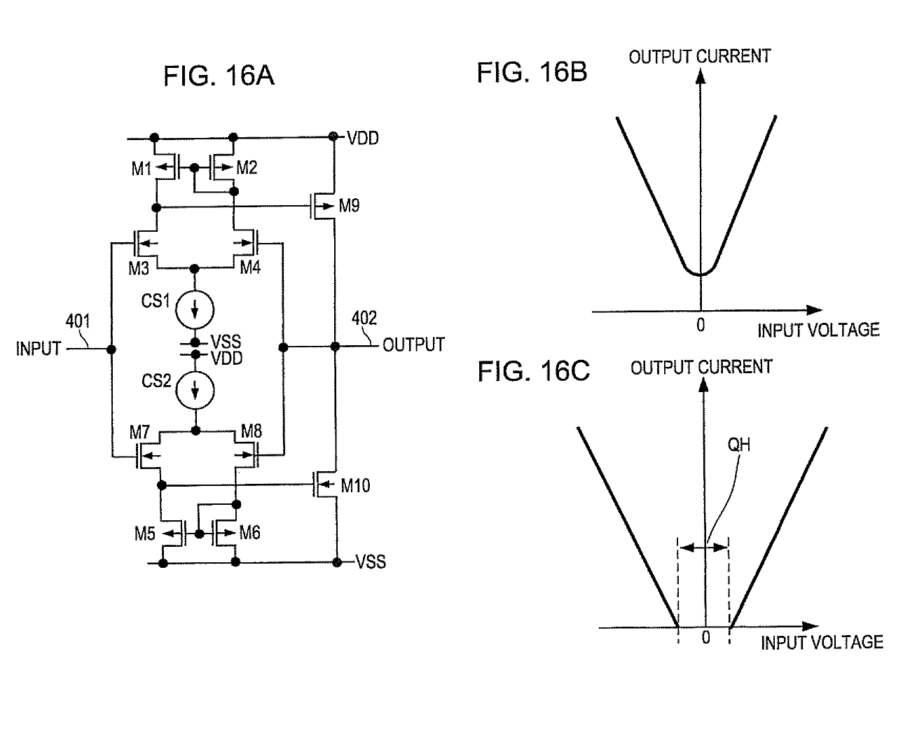

FIGS. 16A to 16C are diagrams for describing an example of the configuration of the Class-B amplifiers each having a dead zone.

In the circuit shown in FIG. 16A, an upper current mirror is intentionally configured to be unbalanced by changing the channel conductance (W/L) of PMOS transistors M1 and M2 constituting the upper current mirror, and a lower current mirror is intentionally configured to be unbalanced by changing the channel conductance (W/L) of NMOS transistors M5 and M6 constituting the lower current mirror, and thereby a dead zone is formed by arranging an offset.

Thus, the amplifier shown in FIG. 16A is not a Class-AB amplifier having an input-output characteristic as shown in FIG. 16B and is a Class-B amplifier having a dead zone QH as shown in FIG. 16C.

Hereinafter, the circuit configuration shown in FIG. 16A and the operation thereof will be described in detail.

The Class-B amplifier circuit shown in FIG. 16A includes an N-channel differential input circuit and a P-channel differential input circuit which use an input terminal 401 and an output terminal 402 as terminals for differential inputs, a P-channel output driving circuit formed by a P-channel MOS transistor M9, and an N-channel output driving circuit formed by an N-channel MOS transistor M10.

The N-channel differential input circuit includes a differential input pair having N-channel MOS transistors M3 and M4, a current mirror having P-channel MOS transistors M1 and M2, and a constant current source CS1. The drain of the P-channel MOS transistor M1 is connected to the drain of the N-channel MOS transistor M3 and the gate of the P-channel MOS transistor M9 of the P-channel output driving circuit.

The P-channel differential input circuit includes a differential input pair having P-channel MOS transistors M7 and M8, a current mirror having N-channel MOS transistors M5 and M6, and a constant current source CS2. The drain of the N-channel MOS transistor M5 is connected to the drain of the P-channel MOS transistor M7 and the gate of the N-channel MOS transistor M10 of the N-channel output driving circuit.

In the N-channel differential input circuit, the channel width of the P-channel MOS transistor M1 constituting the current mirror circuit is set to be wider than that of the P-channel MOS transistor M2 such that the P-channel MOS transistor M9 is necessarily turned off in a case where the voltage levels of the input terminal 401 is the same as the voltage level of the output terminal 402. When the channel width of the P-channel MOS transistor M1 is sufficiently larger than that of the P-channel MOS transistor M2, the voltage between the source and drain of the P-channel MOS transistor has a level equal to or smaller than a threshold value of the P-channel MOS transistor MD in a case where the voltage level of the input terminal 401 is the same as the voltage level of the output terminal 402, and the P-channel MOS transistor M9 is turned off. It may be thought that an offset is given such that the P-channel output driving circuit is necessarily turned off due to the difference between the channel widths of the P-channel MOS transistor M1 and the P-channel MOS transistor M2 in a case where the voltage levels of the input terminal 401 and the output terminal 402 are the same. The channel widths of the N-channel MOS transistor M3 and the N-channel MOS transistor M4 are the same.

As described above, since the N-channel differential input circuit has an offset, the P-channel MOS transistor M9 is in a conductive state in a case where the voltage level of the input terminal 401 is higher than that of the output terminal 402. However, when the voltage level of the input terminal 401 is equal to or lower than that of the output terminal 402, the P-channel MOS transistor M9 is in a non-conductive state.

As described above, in the P-channel differential input circuit, although the channel widths of the P-channel MOS transistor M7 and the P-channel MOS transistor MB are the same, the channel width of the N-channel MOS transistor M5 is set to be larger than that of the N-channel MOS transistor M6. This setting of the channel widths is for arranging an offset that allows the N-channel MOS transistor M10 of the N-channel output driving circuit is necessarily turned off in a case where a same voltage is input to a differential input unit constituted by the P-channel MOS transistor M7 and the P-channel MOS transistor MB due to the difference between the channel widths of the N-channel MOS transistor M5 and the N-channel MOS transistor M6.

Through the offset, in the N-channel differential input circuit as in the P-channel differential input circuit, the N-channel MOS transistor M10 is in a conductive state in a case where the voltage level of the input terminal 401 is lower than that of the output terminal 402. However, when the voltage level of the input terminal 401 is equal to or higher than that of the output terminal 402, the N-channel MOS transistor M10 is in a non-conductive state.

As described above, in the amplifier circuit shown in FIG. 4, when the voltage level of the input terminal 401 with respect to the output terminal 402 is lower than the offset voltage of the N-channel differential input circuit and higher than the offset voltage of the P-channel differential input circuit, the voltage level of the input terminal is in the dead zone, and both the P-channel output driving circuit and the N-channel output driving circuit are turned off, and the output is in a high impedance state.

For example, when the offset voltage of the N-channel differential input circuit is 0.2 V, the offset voltage of the P-channel differential input circuit is −0.2 V, and the voltage level of the output terminal 402 is 2 V, the range of the voltage level of the input terminal 401 from 1.8 V to 2.2 V becomes the dead zone, and the output is in a high impedance state. When the output is in the high impedance state, a consumption current flows only as a bias current of the input terminal.

On the other hand, when the voltage level of the input terminal 401 is beyond the range of the dead zone, one between the P-channel output driving circuit and the N-channel output driving circuit is conducted, and the output terminal is driven such that a difference between the electric potentials of the input terminal 401 and the output terminal 402 decreases.

As described above, the Class-B amplifier shown in FIGS. 16A to 16C implements the dead zone by arranging an offset between the input terminal and the output terminal. In the description above, although a case where the dead zone is arranged in the input by fixing the output voltage has been described, when the input voltage is considered to be fixed, a dead zone is arranged in the output (according to an embodiment of the invention, the latter form is used).

Driving Waveform in Liquid Crystal Device according to Embodiment of Present Invention

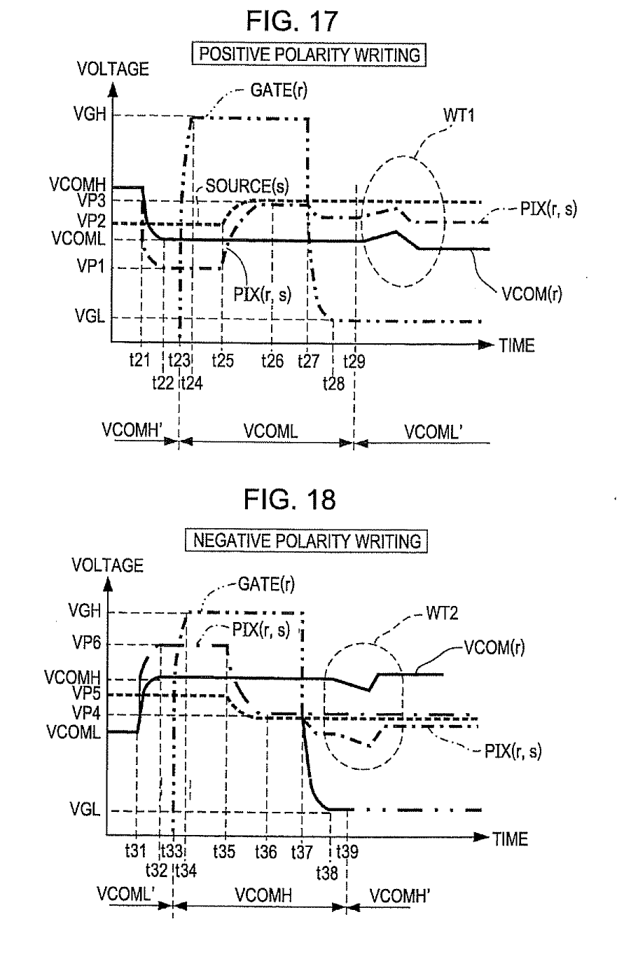

FIG. 17 is a waveform diagram showing driving waveforms for parts of a liquid crystal device according to an embodiment of the invention for writing positive polarity. FIG. 18 is a waveform diagram showing driving waveforms for parts of a liquid crystal device according to an embodiment of the invention for writing negative polarity.

The driving waveforms shown in FIGS. 17 and 18 are basically the same as those shown in FIGS. 6 and 7. However, as described above, while regular common line voltages VCOML and VCOMH are continuously supplied to the common lines Z in FIGS. 6 and 7, in FIGS. 17 and 18, the regular voltages VCOML and VCOMH are supplied during selection periods of the common lines and VCOML′ and VCOMH′ are connected to the common lines in non-selection periods of the common lines, which is different from the waveforms shown in FIGS. 6 and 7.

The common line voltages VCOML′ and VCOMH′ for the non-selection periods have electric potentials of same levels as those of the regular common line voltages VCOML and VCOMH. However, there may be slight voltage variances in the common line voltages VCOML′ and VCOMH′ for the non-selection periods.

Thus, during a period WT1 positioned on the right end of FIG. 17, the voltage VCOM(r) of the r-th row common line slight varies, and the voltage PIX(r,s) of the r-th row and s-th column pixel slight varies correspondingly. However, actually, since the storage capacitor 53 having large capacitance is formed in each pixel, the variance of the pixel voltage does not occur, and thus there is no problem. In addition, during a period WT2 positioned on the right end of FIG. 18, the voltage VCOM(r) of the r-th row common line slight varies, and the voltage PIX(r,s) of the r-th row and s-th column pixel slight varies correspondingly. However, as in FIG. 17, actually, since the storage capacitor 53 having large capacitance is formed in each pixel, the variance of the pixel voltage does not occur, and thus there is no problem.

### Modified Example of Circuit Configuration of Voltage Source for Generating Common Line Voltages VCOML′ and VCOMH′ for Non-Selection Period

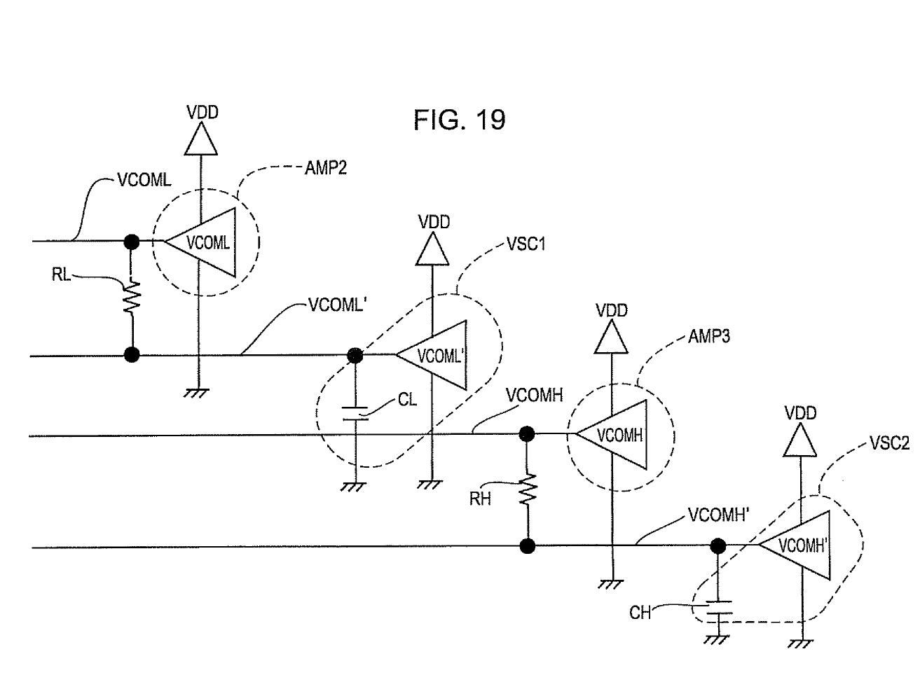

FIG. 19 is a diagram showing a modified example of the circuit configuration of the voltage source that generates the common line voltages VCOML′ and VCOMH′ for the non-selection period.

As shown in FIG. 19, between lines VCOML and VCOML′, a bias resistor RL having high resistance is disposed. In addition, between lines VCOMH and VCOMH′, a bias resistor RH having high resistance is disposed.

Under this configuration, bias points (center voltage levels in a case where voltage levels vary) of VCOML′ and VCOMH′ are regular voltages VCOMH and VCOML. Accordingly, the voltage variances of VCOML′ and VCOMH′ have the regular voltages VCOMH and VCOML as centers of the variations. As a result, there is a high possibility that the voltage variations are within the allowed range. Thereby, it is possible to effectively reduce power consumption by using the dead zone of the Class-B amplifier for VCOMH′ and VCOML′.

In FIG. 19, it is also possible to reduce power consumption due to idling currents of the VCOMH′ amplifier and the VCOML′ amplifier with maintaining the OFF state of pixel transistors by setting the capacitors CH and CL and bias resistors RH and RL to appropriate values.

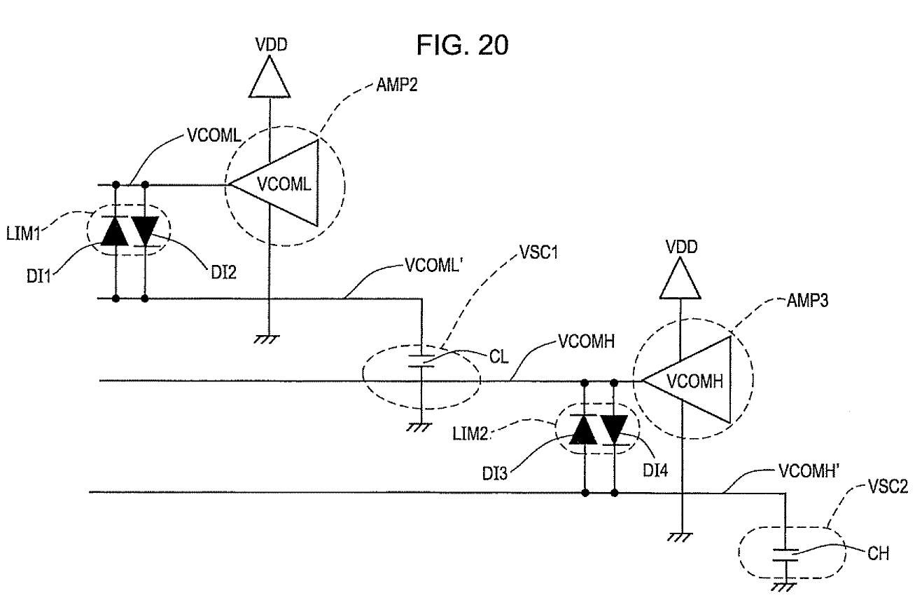

FIG. 20 is a diagram showing another modified example of the circuit configuration of the voltage source that generates the common line voltages VCOML′ and VCOMH′ for the non-selection period.

As shown in FIG. 20, a voltage limiter LIM1 constituted by bi-directional diodes DI1 and DI2 is disposed between the lines VCOML and VCOML′. In addition, a voltage limiter LIM2 constituted by bi-directional diodes DI3 and DI4 is disposed between the lines VCOMH and VCOMH′. In this case, the voltage variations of VCOML′ and VCOMH′ are regulated based on the regular voltages VCOMH and VCOML, and accordingly, there is a high possibility that the voltage variations are within the allowed range. Thereby, it is possible to effectively reduce power consumption by using the dead zone of the Class-B amplifier for VCOMH′ and VCOML′.

The circuit configuration of the voltage source that generate the common line voltages VCOML′ and VCOMH′ for the non-selection period is not limited to the above-described example, and various changes in forms may be made therein. For example, when voltage variations of VCOMH′ and VCOML′ are allowed to some degree, the VCOMH′ amplifier and the VCOML′ amplifier may be stopped or removed.

A modified example in which the VCOMH′ amplifier and the VCOML′ amplifier may be stopped only in a low power consumption mode may be used. As a case where the lower power consumption mode is used, a binary display process or a partial display process may be considered. In such a case, the power consumption can be reduced by turning on/off the amplifiers in accordance with a display mode.

FIG. 21 is a diagram showing another modified example of the circuit configuration of the voltage source that generates the common line voltages VCOML′ and VCOMH′ for the non-selection period.

In FIG. 21, a switch SW1 is disposed between the lines VCOML and VCOML′, and similarly, a switch SW2 is disposed between the lines VCOMH and VCOMH′.

By turning on the switches SW1 and SW2, the electric potentials (bias points) of VCOML′ and VCOMH′ converges to the electric potentials of the regular voltages VCOMH and VCOML in a speedy manner. Thus, the electric potentials (DC bias) can be stabilized. Accordingly, the voltage variances of VCOML′ and VCOMH′ have the regular voltages VCOMH and VCOML as centers of the variations. As a result, there is a high possibility that the voltage variations are within the allowed range. Thereby, it is possible to effectively reduce power consumption by using the dead zone of the Class-B amplifier for VCOMH′ and VCOML′.

The switches SW1 and SW2 may be used alone, used together with the above-described bias resistors RH and RL, or used together with the limiters LIM1 and LIM2 constituted by bi-directional diodes. Particularly, it is useful to use the switches together with the bias resistors RL and RH.

In other words, since resistance of the bias resistors RL and RH is quite high, the bias resistors alone need a corresponding time for stabilizing the electric potentials (DC bias). However, by using the switches SW1 and SW2 together, it is possible to quickly stabilize the electric potentials (DC bias) of output terminals of the auxiliary positive polarity voltage source and the auxiliary negative polarity voltage source at a desired timing.

As a timing for turning on the switches SW1 and SW2, various timings may be used. It is useful to turn the switches SW1 and SW2 for a predetermined time at a time when the operation of the liquid crystal device is started. In such a case, when the operation of the liquid crystal device is initially started, it is possible to stabilize the electric potentials (DC bias) of output terminals of the auxiliary positive polarity voltage source and the auxiliary negative polarity voltage source in a speedy manner.

In addition, it is useful to turn on the switches SW1 and SW2 for a predetermined time at predetermined time intervals in a period when the whole scanning lines are in the non-selection period. The switches may be turned on periodically, and the switches may be turned on in a period other than an image display period. If the switches are turned on when the whole scanning lines are not selected (for example, in a blanking interval), there is an advantage that a display image is not affected. In addition, when the switches are periodically turned on, it is possible to continuously stabilize the electric potentials (DC bias) of output terminals of the auxiliary positive polarity voltage source and the auxiliary negative polarity voltage source.

FIG. 22 is a diagram showing another modified example of the circuit configuration of the voltage source that generates the common line voltages VCOML′ and VCOMH′ for the non-selection period. As shown in FIG. 22, the VCOMH′ amplifier and the VCOML′ amplifier are not provided, and the voltage sources VSC1 and VSC2 for non-selected common lines are constituted only by the capacitors CL and CH. This configuration also belongs to the scope of the present invention.

### Second Embodiment

In this embodiment, an example of an electronic apparatus in which an active matrix-type liquid crystal device (electro-optical device) according to an embodiment of the invention is installed will be described.

### Projector

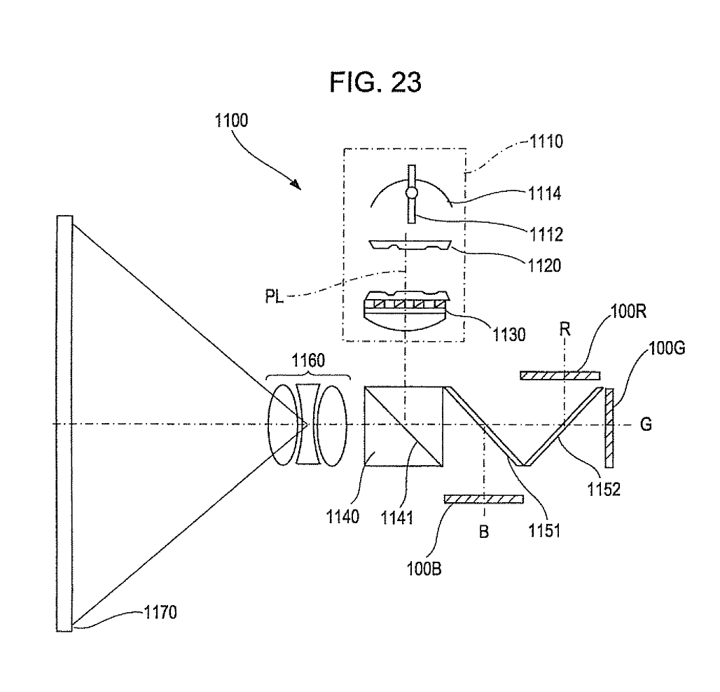

First, a projector in which an electro-optical device according to an embodiment of the invention is used as a light valve will be described. FIG. 23 is a diagram showing the whole configuration of a projector including an electro-optical device (reflection-type liquid crystal device) according to an embodiment of the invention.

As shown in the figure, inside the projector 1100, a polarized lighting device 1110 is disposed along the optical axis PL of the system. In the polarized lighting device 1110, light emitted from a lamp 1112 becomes light fluxes substantially parallel to one another due to reflection of a reflector 1114, and the light fluxes are incident to a first integrator lens 1120. Accordingly, the light emitted from the lamp 1112 is divided into a plurality of intermediate light fluxes. These divided intermediate light fluxes are converted into one type of polarized light fluxes (s polarized light fluxes) having a substantially constant polarized direction by a polarization conversion element 1130 having a second integrator lens disposed on the light incident side and are emitted from the polarized lighting device 1110.

The s-polarized light fluxes emitted from the polarized lighting device 1110 are reflected by an s-polarized light flux reflecting surface 1141 of a polarization beam splitter 1140. Among these reflected light fluxes, light fluxes of blue light B are reflected by a blue light reflecting layer of a dichroic mirror 1151 and are modulated by a reflection-type electro-optical device 100B. In addition, among the light fluxes transmitted through the blue light reflecting layer of the dichroic mirror 1151, light fluxes of red light R are reflected by a red light reflecting layer of a dichroic mirror 1152 and are modulated by a reflection-type electro-optical device 100R.

In addition, among the light fluxes transmitted through the blue light reflecting layer of the dichroic mirror 1151, light fluxes of green light G are transmitted through the red light reflecting layer of the dichroic mirror 1152 and are modulated by a reflection-type electro-optical device 100G.

As described above, the light fluxes of the red light, the green light, and the blue light modulated by the electro-optical devices 100R, 100G, and 100B are sequentially composed by the dichroic mirrors 1152 and 1151 and the polarization beam splitter 1140 and are projected on a screen 1170 by a projection optical system 1160. Since light fluxes corresponding to the original colors of R, G, and B are incident to the electro-optical devices 100R, 100B, and 100G by the dichroic mirrors 1151 and 1152, a color filter is not needed.

There is an advantage that the projector shown in FIG. 23 has a superior characteristic for low power consumption. For example, the projector is useful as a projector for a home theater.

In the above-described example, although a reflection-type electro-optical device is used, a projector using a projection-type electro-optical device may be configured.

### Mobile Computer

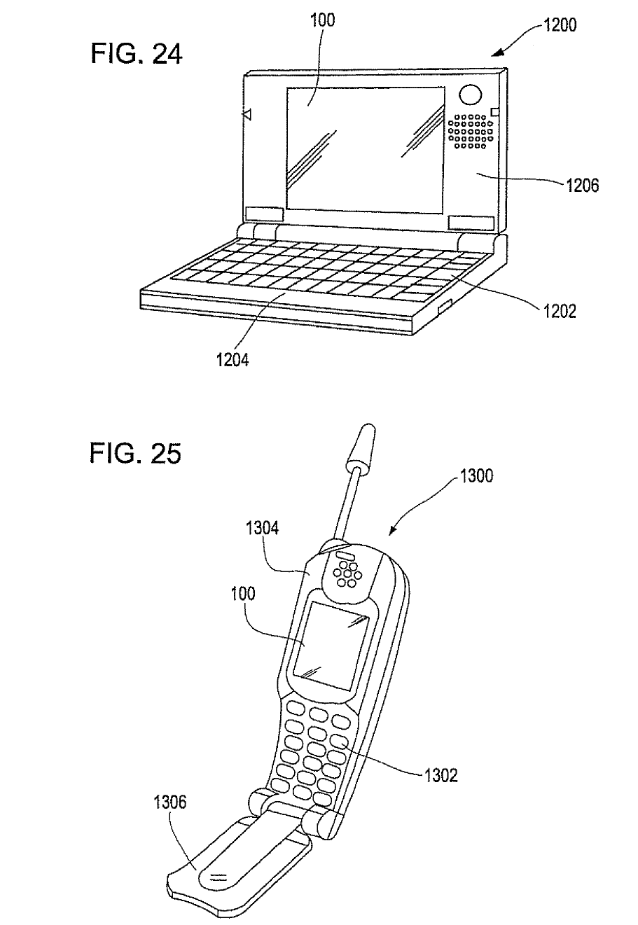

Next, an example in which an electro-optical device according to an embodiment of the invention is used for a mobile personal computer will be described. FIG. 24 is a perspective view showing the configuration of a personal computer including an electro-optical device according to an embodiment of the invention.

In FIG. 24, a computer 1200 is constituted by a main unit 1204 having a keyboard 1202 and a display unit 1206. This display unit 1206 is configured by adding a front light on a front side of the above-described electro-optical device 100. Under this configuration, since the electro-optical device 100 is used as a reflection direct-view type, it is preferable that concaves and convexes are formed in pixel electrodes 118 for scattering reflected light in various directions.

Since the mobile computer shown in FIG. 24 has a superior characteristic for low power consumption, there is an advantage that the durability of a battery can be improved.

### Mobile Terminal

FIG. 25 is a perspective view showing the configuration of a mobile terminal (here, a mobile phone) having an electro-optical device according to an embodiment of the invention. In the figure, the mobile phone 1300 has the electro-optical device 100 in addition to a plurality of operation buttons 1302, an earpiece 1304, and a mouthpiece 1306. On the front side of the electro-optical device 100, a front light is disposed as is needed. Under this configuration, since the electro-optical device 100 is used as a reflection direct-view type, it is preferable that concaves and convexes are formed in pixel electrodes 118 for scattering reflected light in various directions.

Since the mobile terminal shown in FIG. 25 has a superior characteristic for low power consumption, there is an advantage that the durability of a battery can be improved.

In addition, the present invention may be applied to other electronic devices (for example, a liquid crystal television set, a view finder-type or a monitor direct view-type video cassette recorder, a car navigation system, a pager, an electronic diary, a calculator, a word processor, a workstation, a video phone, a POS terminal, a device having a touch panel, or the like). According to an embodiment of the invention, a low-cost electro-optical device capable of high precision display can be acquired.

Although embodiments of the invention have been described, it will be easily understood by those of ordinary skill in the art that various changes may be made therein without departing from the gist of the invention. Accordingly, such modified examples belong to the scope of the invention. For example, as the electro-optical material, various materials of which transmittance changes by application of a voltage may be used. In addition, a modified pixel circuit in which the switching elements are constituted by diodes instead of transistors belongs to the technical scope of the invention.

As described above, according to an embodiment of the invention, the following major advantages can be acquired.

(1) It is possible to implement a liquid crystal device having a pixel configuration in which one terminal of the storage capacitance and the common electrode are connected with a common line and being driven by alternately inverting the polarity of the driving voltage of the common line.
(2) When each pixel connected to a common line is completely switched from a selection period to a non-selection period, the connection target of the common line is switched to the auxiliary voltage source having a simple configuration correspondingly. Accordingly, the load of the regular amplifier that drives the common lines is reduced, and it is possible to provide voltage levels to the common lines in the selection period with high precision.
(3) Power consumption due to crosstalk currents flowing through parasitic capacitance can be effectively reduced.
(4) The liquid crystal device according to an embodiment of the invention can be implemented, for example, by adding a voltage source of a simple configuration which uses capacitors as a main body. Accordingly, the liquid crystal device can be practically used in an easy manner.

Although embodiments of the invention have been described in detail, it will be understood by those of ordinary skill in the art that various changes may be made therein without departing from new matters and advantages of the invention. Accordingly, such modified examples belong to the scope of the invention.

The present invention is appropriate to be used for a display unit of a cellular phone, a personal computer, an information mobile terminal, a digital still camera, a liquid crystal television set, a view finder-type or direct view-type video cassette recorder, a car navigation system, a pager, an electronic diary, a calculator, a word processor, a workstation, a video phone, a POS terminal, a device having a touch panel, or the like.

The entire disclosure of Japanese Patent Application No. 2007-088282, filed Mar. 29, 2007 is expressly incorporated by reference herein.

What is claimed is:

1. A liquid crystal device comprising:
a first substrate having a plurality of scanning lines, a plurality of data lines, a plurality of pixel electrodes disposed in correspondence with intersections of the plurality of scanning lines and the plurality of data lines, and common electrode disposed to face the pixel electrodes;
a second substrate disposed to face the first substrate;
a liquid crystal interposed between the first substrate and the second substrate;
a scanning line driving circuit that sequentially supplies selection voltages for selecting the scanning lines to the plurality of scanning lines;
a regular voltage source that supplies a first voltage, which is a regular common electrode voltage having a negative polarity, and a second voltage, which is a regular common electrode voltage having a positive polarity, to be applied to the common electrode corresponding to a pixel in a selection period;
an auxiliary voltage source that supplies a third voltage, which is an auxiliary common electrode voltage having a negative polarity, and a fourth voltage, which is an auxiliary common electrode voltage having a positive, to be applied to the common electrode corresponding to a pixel in a non-selection period;
a control circuit that selects one from among the first voltage, the second voltage, the third voltage, and the fourth voltage and supplies the selected voltage to the common electrode; and
a data line driving circuit that alternately supplies a positive-polarity image signal and a negative-polarity image signal to the plurality of data lines when the scanning line is selected,
wherein the control circuit supplies the first voltage to the common electrode, the scanning line driving circuit supplies the selection voltage to the scanning lines, the data line driving circuit supplies the positive polarity image signal to the data lines, and the control circuit supplies the third voltage to the common electrode after the supply of the selection voltage to the scanning lines is stopped, and
wherein the control circuit supplies the second voltage to the common electrode, the scanning line driving circuit supplies the selection voltage to the scanning lines, the data line driving circuit supplies the negative polarity image signal to the data lines, and the control circuit supplies the fourth voltage to the common electrode after the supply of the selection voltage to the scanning lines is stopped.

2. The liquid crystal device according to claim 1, wherein the common electrode is divided for each horizontal line.

3. The liquid crystal device according to claim 2, wherein the control circuit supplies the second voltage or the fourth voltage to the even row common electrodes when supplying the first voltage or the third voltage to the odd row common electrodes.

4. The liquid crystal device according to claim 1,
wherein the auxiliary voltage source for supplying the third voltage and the fourth voltage includes a capacitor that is charged or discharged through a crosstalk current flowing through parasitic capacitance intervening between the data lines and the common electrode, and
wherein the level of the third voltage is equivalent to or approximately equal to that of the first voltage and the level of the fourth voltage is equivalent to or approximately equal to that of the second voltage.

5. The liquid crystal device according to claim 4, wherein the auxiliary voltage source further includes a voltage limiting unit that limits the range of voltage variances of a voltage generated from the capacitor.

6. The liquid crystal device according to claim 5, wherein the voltage limiting unit is a Class-B amplifier having its output terminal connected to one end of the capacitor and having a dead zone of a predetermined width.

7. The liquid crystal device according to claim 6, wherein the Class-B amplifier is turned on or off in accordance with an operation mode of the liquid crystal device.

8. The liquid crystal device according to claim 1,
wherein the regular voltage source includes a regular negative polarity voltage source that supplies the first voltage and a regular positive polarity voltage source that supplies the second voltage,
wherein the auxiliary voltage source includes an auxiliary negative polarity voltage source that supplies the third voltage and an auxiliary positive polarity voltage source that supplies the fourth voltage,
wherein a voltage supply terminal of the auxiliary negative polarity voltage source is connected to an output terminal of the regular negative polarity voltage source through a first bias resistor, and
wherein a voltage supply terminal of the auxiliary positive polarity voltage source is connected to an output terminal of the regular positive polarity voltage source through a second bias resistor.

9. The liquid crystal device according to claim 1,
wherein the regular voltage source includes a regular negative polarity voltage source that supplies the first voltage and a regular positive polarity voltage source that supplies the second voltage,
wherein the auxiliary voltage source includes an auxiliary negative polarity voltage source that supplies the third voltage and an auxiliary positive polarity voltage source that supplies the fourth voltage,
wherein a voltage supply terminal of the auxiliary negative polarity voltage source is connected to an output terminal of the regular negative polarity voltage source through a first limiter including a bi-directional diode, and
wherein a voltage supply terminal of the auxiliary positive polarity voltage source is connected to an output terminal of the regular positive polarity voltage source through a second limiter including a bi-directional diode.

10. The liquid crystal device according to claim 1,
wherein the regular voltage source includes a regular negative polarity voltage source that supplies the first voltage and a regular positive polarity voltage source that supplies the second voltage,
wherein the auxiliary voltage source includes an auxiliary negative polarity voltage source that supplies the third voltage and an auxiliary positive polarity voltage source that supplies the fourth voltage,
wherein a voltage supply terminal of the auxiliary negative polarity voltage source is connected to an output terminal of the regular negative polarity voltage source through a first switch, and
wherein a voltage supply terminal of the auxiliary positive polarity voltage source is connected to an output terminal of the regular positive polarity voltage source through a second switch.

11. The liquid crystal device according to claim 10, wherein the first switch and the second switch are turned on for a predetermined time when the operation of the liquid crystal device is started.

12. The liquid crystal device according to claim 10, wherein the first switch and the second switch are turned on for a predetermined time at predetermined time intervals in a period when the total scanning lines are not selected.

13. A control circuit comprising:
a first substrate having a plurality of scanning lines, a plurality of data lines, a plurality of pixel electrodes disposed in correspondence with intersections of the plurality of scanning lines and the plurality of data lines, and common electrode disposed to face the pixel electrodes;
a second substrate disposed to face the first substrate;
a liquid crystal interposed between the first substrate and the second substrate;
a first voltage source used as a regular voltage source for supplying a first voltage that is a negative polarity regular common electrode voltage;
a second voltage source used as a regular voltage source for supplying a second voltage that is a positive polarity regular common electrode voltage;
a third voltage source used as an auxiliary voltage source for supplying a third voltage that is a negative polarity auxiliary common electrode voltage, which has a level equivalent to or approximately the same as that of the first voltage, to be applied to the common electrodes corresponding to pixels in the non selection period;
a fourth voltage source used as an auxiliary voltage source for supplying a fourth voltage that is a positive polarity auxiliary common electrode voltage, which has a level equivalent to or approximately the same as that of the second voltage, to be applied to the common electrodes corresponding to pixels in the selection period; and
a switching circuit for selecting one from among the first voltage, the second voltage, the third voltage, and the fourth voltage and applying the selected voltage to the common electrodes.

14. An electronic apparatus having the liquid crystal device according to claim 1.

15. A method of driving a liquid crystal device having a first substrate having a plurality of scanning lines, a plurality of data lines, a plurality of pixel electrodes disposed in correspondence with intersections of the plurality of scanning lines and the plurality of data lines, and common electrode disposed to face the pixel electrodes, a second substrate disposed to face the first substrate, and a liquid crystal interposed between the first substrate and the second substrate, the method comprising:
supplying a first voltage as a negative polarity regular common electrode voltage to the common electrodes corresponding to pixel electrodes when the scanning lines have an active level and a positive polarity writing voltage is supplied to the pixel electrodes from the data lines;
supplying a second first voltage as a negative polarity auxiliary common electrode voltage which has a level equivalent to or almost the same as that of the first voltage and supplied from a voltage source other than the voltage source of the first voltage to the common electrodes when the scanning lines change to an inactive level;
supplying a third voltage as a positive polarity regular common electrode voltage to the common electrodes corresponding to pixel electrodes when the scanning lines have the active level and a negative polarity writing voltage is supplied to the pixel electrodes from the data lines; and
supplying a fourth voltage as a positive polarity auxiliary common electrode voltage which has a level equivalent to or almost the same as that of the third voltage and supplied from a voltage source other than the voltage source of the third voltage to the common electrodes when the scanning lines change to an inactive level.

16. The method according to claim 15, wherein the common electrode is divided for each horizontal line and opposite polarity voltages are applied to the common electrodes located in adjacent rows.
